(19) United States
(12) Patent Application Publication
(10) Pub. No.: US 2023/0214279 A1
(43) Pub. Date: Jul. 6, 2023

(54) EVENT MANAGEMENT SYSTEM FOR CONTROLLING INTERACTIONS BETWEEN PARTICIPANTS BY USING MEMBER SCOPES

(71) Applicant: ASANUMA HOLDINGS CO., LTD., TOKYO (JP)

(72) Inventor: KATSUHIDE ASANUMA, YAMANASHI (JP)

(21) Appl. No.: 17/996,035

(22) PCT Filed: Apr. 9, 2021
(86) PCT No.: PCT/JP2021/015034

§ 371 Date: Oct. 12, 2022

(30) Foreign Application Priority Data
Apr. 15, 2020 (JP) 2020-073001

(51) Int. Cl. G06F 9/54; G06F 8/34; G06F 8/38

(52) U.S. Cl. CPC G06F 9/542; G06F 8/34; G06F 8/38

(57) ABSTRACT

[Problem]

To allow an event creator to create an executable program easily

[Means of Solution]

An event management system comprising an API database that stores an event execution management API and a resource management API,
an event database, an API registration processing unit, an event creation processing unit, an event registration processing unit that determines whether an event execution program accords with criteria and registers, in the event database, an event execution program whose result is affirmative,
and a communication processing unit that carries out transmission and reception, wherein the event execution program controls, by using an object called a member scope which is an array of groups and is a set of participant groups, an interaction between a plurality of event participants or a plurality of devices, and further executes control by using an attribute, a current processing group, and one or more functions to perform a set operation or a relevance extraction operation.

### TECHNICAL FIELD

The present invention is for an event management system that administers and manages an event by using a computer network.

### BACKGROUND ART

When an event such as an excursion, a group trip, a publication commemorating party, a new year's greeting party, a name card exchange party, a birthday party, a meet-up, a quiz competition, a music concert, a live concert, a stamp rally, an orienteering competition, or a wedding ceremony is implemented, a participant desires to retrieve personal information highly correlated statistically with his or her own personal information on hobbies, tastes and so on. Additionally, since the retrieval is often carried out by using a portable terminal device whose screen is relatively small, such as a cell phone including a smart phone, efforts are made so that even with a small display screen, the retrieval can be made efficiently. Patent document 1 discloses an information providing system that allows such retrieval to be carried out.

Additionally, an event management system and method where both an implementer and a participant are registered as a member in an event, where the event is smoothly implemented, and where the implementer and the participant can be properly managed is desired. In order to solve such a problem, Patent document 2 discloses an event management system that is made of a member terminal and an event management server, and manages, on the event management server's side, progress for the event, wherein the event management server has a member information storing means, an event implementation/participation condition information receiving means, a potential participating member extracting means, an event implementation reporting means, a participation application receiving means, a participation point granting means, a questionnaire implementing means, a questionnaire point granting means while the member terminal has an event implementation information receiving means, an event participation application sending means and a questionnaire answering means.

Furthermore, since it is difficult to allow an event management program that works on an event management server to be diverted into another event, it is not possible to obtain desired cost-effectiveness for holding an event. A system design for allowing bar code reader function, moving image capturing function, infrared transmitting/receiving function, and so on, which are additional functions of a user terminal, is complicated and laborious. In order to address such a problem, Patent Document 3 proposes that the basic functions of a server in event management and operation be constructed as an API (application program interface). That is a communication function API, a participant information management API, a scene node management API (an event scene generation API, a scene execution API, etc.), a market API for goods trading, an advertisement distribution API, an interface for participant terminal accessory equipment, or the like.

Further, Patent Document 3 says that in order to raise motivation for participants by using attribute information obtained through an event on the participants, a function of storing the attribute information and behavior information on such participants as a life log and promoting, by using this, communication between the participants is provided.

Patent Document 4 discloses an event management system having an event plan creation management means that constructs, from a structured document, an event plan or event plan components and combines them to create a feasible event plan, and an event execution means that delivers messages to and accepts responses from participant terminals, and controls the progress of an event.

### PRIOR ART

### Patent Documents

Patent Document 1: Japanese Patent No. 5158302
Patent Document 2: Japanese Patent No. 5072003
Patent Document 3: Japanese Patent No. 5182854
Patent Document 4: JP-A-2009-176269

### Overview of Invention

### Problem to be Solved by the Invention

However, a simpler user interface has been desired by a party that creates an event and a party that participates in the event. Furthermore, it is desired to be excellent in interaction control between participants.

The present invention has been made in view of such circumstances, and is intended to provide an event management system that can realize a program making it easy for users to create an event or participate in the event and being excellent in interaction control between participants and between devices.

### Means to Solve the Problem

The present invention is intended to provide an event management system characterized by controlling an interaction between a plurality of event participants or a plurality of devices by using an object called a member scope which is an array of groups and is a set of participant groups.

The event management system according to the present invention is characterized by comprising

an API database that string an event execution management API that executes and manages at least one of scenario execution as a constitutional unit of an event, transmission of messages to and reception thereof from event participant terminals, processing of location information on the event participant terminals, event progress recording, log data collection, and advertisement distribution, and a resource management API that identifies and manages each physical resource including at least one of a terminal to be operated by the event execution management API, a device, an article of commerce, a building, a place, means of transportation, and means of communication;
an event database that stores an event execution program, and log data generated during such event execution;
an API registration processing unit that receives an API according with a given API definition specification from an API provider terminal and registers it in the API database;
an event creation processing unit that transmits, to an event creator terminal used by an event creator, a given event definition specification and any API selected among APIs stored in the API database and receives, in the event creator terminal, an event execution program created by making an API received in accordance with the event definition specification be a component thereof;
an event registration processing unit that determines whether the created event execution program accords with given criteria for feasibility in the present system and registers, in the event database, an event execution program whose result is affirmative; and
a communication processing unit that transmits information necessary for or related to event execution to and receives it from event participant terminals used by event participants, through a network;
wherein the event execution program controls, by using an object called a member scope which is an array of groups and is a set of participant groups to limit participants by the member scope, an interaction between a plurality of the event participants or a plurality of the devices.

These can allow an event management system excellent in interactions between participants, to be provided.

Further, it is characterized in that the above event execution program executes control by using an attribute of having an attribute value defined for any one or more of objects constituting the above member scope and unique to an object instance,

means of specifying an attribute value by a group context for processing, and one or more functions to perform a set operation or a relevance extraction operation.

This allows a relationship between a plurality of groups to be controlled and an interaction between participants to be controlled.

It is characterized in that the above means of specifying attribute values includes any one or more of the limitation on participants by a member scope, a current processing group of a member scope, or the limitation on participants by a member scope higher with respect to inclusion relationship.

This can allow a relationship between a plurality of groups to be controlled and an interaction between participants to be controlled.

Additionally, it is characterized in that the above one or more functions to perform a set operation or a relevance extraction operation include

a function that performs a logical operation,
a function that performs relevance extraction between membership objects
a function that performs member scope member group additions and deletions, and a function that performs member scope member additions and deletions.

This ensures, even in a case that addition, deletion or the like is made as for members, whole interaction control.

It is characterized by expressing, in a parent-child relationship, a scenario or a time zone by combining a user interface block as a block of the above event execution program, a program block, and an evaluation range as a transition dendrogram of the program blocks.

This can realize programming easy for event creators to understand.

It is characterized by expressing, in a parent-child relationship, a scenario or a time zone by a user interface block as a block of the above event execution program or an inclusion block including a plurality of program blocks.

This can realize programming easy for event creators to understand and high in degree of freedom.

It is characterized in that the above user interface block is made of an event creator user interface block and an event participant user interface block, and that

the above event execution program is run by mutual interrupts of a plurality of event creator user interface blocks.

This can realize programming easy for event creators to understand.

It is characterized in that the above event execution program has a constraint to act as a block initiation condition, and that

the above mutual interrupts of a plurality of event creator user interface blocks are integrally managed by the constraint.

This can realize programming easy for event creators to understand.

Further, it is characterized in that the above event execution program has a constraint to act as a block initiation condition, and that

the above member scope is integrally managed by the constraint.

This allows an event creator to manage participants in a way easy to understand.

It is characterized in that the above event execution program has an interaction connector as a program block to acquire evaluation time information and group information on a transition source and return, if conditions are satisfied when a transition occurs in a transition source group, an evaluation time to a transition destination group, and

manages whole processing and mutual processing by using the interaction connector.

This allows a transition easy for an event creator to understand.

It is characterized by having an event-driven evaluation processing unit that executes page display and user input/output in the process of executing such evaluation.

This allows an event creator to carry out highly feasible programming.

It is characterized in that the above event execution program executes transition timing management by carrying out comparison control between evaluation times, and between addition time operation and current time.

This allows transition timing to be managed appropriately.

It is characterized in that the above event execution program graphically displays icons including user interface blocks, program blocks, and input/output ports. This allows an event creator to carry out graphical programming.

It is characterized in that the above event execution program displays, when an event occurs in a related icon among a user interface block, a program block, and input/output ports, a transition arrow leading to the icon and displays, otherwise, only an icon representing a mutual port.

This allows such display to be avoided from being complicated and the display to be limited to only a required transition arrow.

It is characterized in that a new lower member scope defined in the above inclusion block where participants are limited by the above member scope is created and managed by a child process where participants are limited by a higher member scope, and that

members of a group belonging to the lower member scope constitute a subset of an active group of a higher member scope.

This appropriately forms a member scope represented by a parent-child relationship.

Furthermore, it is characterized in that the above event execution program is made by combining a user interface, a user interface block (UIB) used for controlling timing and contexts for the user interface, a program block (PB) to define such control in detail, and that the above event registration processing unit registers, by executing, for the event execution program, event-driven evaluation processing on the basis of an evaluation range as a transition dendrogram of program blocks surrounded by variable blocks, an event execution program according with the above given criteria for feasibility in the above event database. This allows a scope within which to evaluate program validity to be determined and driven evaluation processing to be carried out appropriately.

### Advantageous Effects by Invention

As described above, it is possible to provide an event management system that is excellent in interaction between participants.

### BRIEF DESCRIPTION OF DRAWINGS

FIG. 1 A diagram to show a structure of a scenario

FIG. 2 A diagram to show a BUI function model (Base layer-A control unit with no graphic element)

FIG. 3 A diagram to describe a business program block (BPB)

FIG. 4 A diagram to describe an inclusive type

FIG. 5 A diagram to describe a module

FIG. 6 A diagram to describe a BUI group

FIG. 7 A diagram to describe a BUI group (group context)

FIG. 8 A diagram to describe a reference scope and a function sheet for a block

FIG. 9 A diagram to describe a variable and an attribute

FIG. 10 A diagram to describe an evaluation range of a UIB (user interface block)

FIG. 11 A diagram to describe a PB evaluation range of a B-UIB

FIG. 12 A diagram to describe a BUI (business user interface) function model—an editorial operation model (partially taking a GUI into account)

FIG. 13 A diagram to map model function operation

FIG. 14 A diagram to describe a BUI function model (Practical layer—A control unit with no graphic element)

FIG. 15 A diagram to show that a member scope gives a group context to a BUIB

FIG. 16 A diagram to describe a system setting attribute

FIG. 17 A diagram to describe an entry condition definition and a related participant specification (Part 1)

FIG. 18 A diagram to describe an entry condition definition and a related participant specification (Part 2)

FIG. 19 A diagram to describe an object relationship definition, a constraint definition, an MS attribute definition, and timing transition

FIG. 20 A diagram to describe an interaction connector, display and responses, a constraint, a member scope constraint, MS log acquisition, and an attribute

FIG. 21 A diagram to describe a time zone constraint, a field zone constraint, BUIB process, and a basic PB

FIG. 22 A diagram to describe order calculation, an administrator trigger, external trigger wait-reception PB, a response BUIB, event status generation, context-limited page issuance, and URL issuance

FIG. 23 A diagram to describe the grant of constraint function to a connected UIB, and to describe status evaluation, administrator contact

FIG. 24 A diagram to describe a module list

FIG. 25 A diagram to describe object count extraction and active group specification

FIG. 26 A diagram to describe function of a header

FIG. 27 A diagram to show relationships between a constraint and a header or footer

FIG. 28 A diagram to describe a graphical unit (icons and palettes) of a BUI

FIG. 29 A diagram to describe a field zone definition attribute icon

FIG. 30 A diagram to show an example of division

FIG. 31 A diagram to show an example of division (sequel).

FIG. 32 A diagram to describe a transition arrow

FIG. 33 A diagram to describe status iconization/display

FIG. 34 A diagram to describe graphical operations (related to function models) in an example of division

FIG. 35 A diagram to describe graphical operations (related to function models) in an example of division (sequel)

FIG. 36 A diagram to describe a display context specification tag

FIG. 37 A diagram to describe dispositional relationships between diagrams from FIG. 38 to FIG. 41

FIG. 38 A diagram to describe the embodiment example (Part 1)

FIG. 39 A diagram to describe the embodiment example (Part 2)

FIG. 40 A diagram to describe the embodiment example (Part 3)

FIG. 41 A diagram to describe the embodiment example (Part 4)

FIG. 42 A diagram to show a hardware constitution of an event management system

FIG. 43 A diagram to show how a sever computer constituting an event management system is constituted.

FIG. 44 A diagram to show the aspect of interactions (FIG. 44(a)) and a diagram to show the parent-child relationship between member scopes (FIG. 44(b))

### MODES FOR CARRYING OUT THE INVENTION

The best mode for carrying out the management system according to the present invention shall be described in detail below with reference to the attached drawings. FIGS. 1 to 43 are diagrams exemplifying embodiment modes for the present invention, and in those diagrams, portions given an identical reference numeral denote an identical matter, which shall be identical in basic constitution and operation.

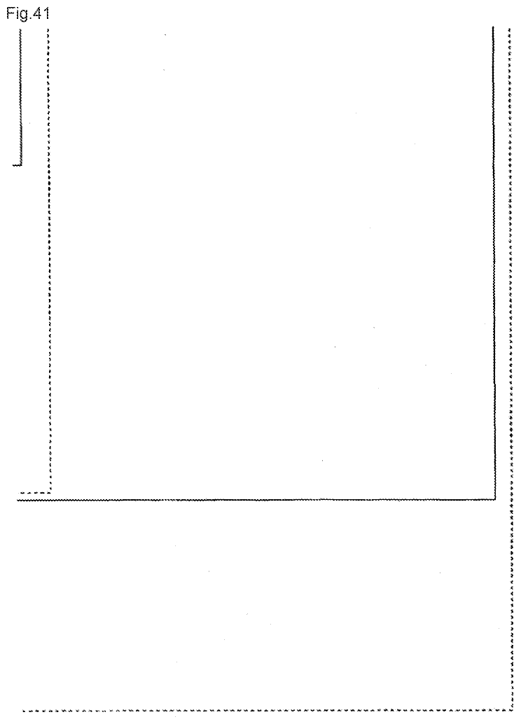

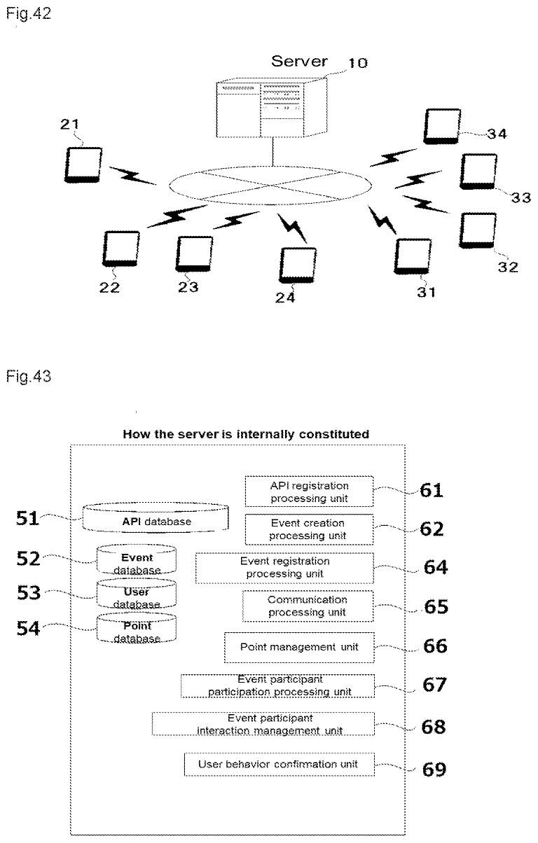

FIG. 42 is a diagram to show a hardware constitution of an event management system. The Internet network indicated by an oval in the center of FIG. 42 represents a server (server computer) 10, administrator user terminals 21, 22, 23, 24 from which an administrator user (business user) who creates an event acquires an administrator user account to access the server 10, and ordinary user (participant user) terminals 31, 32, 33, 34. The administrator user terminals and the ordinary user terminals can be a combination between a so-called smart phone, tablet computer, IC card or QR written card, and a reading device and display, and a sounding device. Although FIG. 42 depicts the terminals in a manner that they are communicating directly with the Internet, the terminals may be ones that can be connected to the Internet via a Wi-Fi device. They may also be ones that can be connected to the Internet via a mobile phone network.

FIG. 43 is a diagram to show how a sever computer 10 constituting an event management system is constituted.

The server computer 10 has an API database device 51 that stores an event execution management API (application program interface) that executes and manages scenario execution as a constitutional unit of an event, transmission of messages to and reception thereof from event participant terminals, processing of location information on the event participant terminals, event progress recording, log data collection, advertisement distribution, and so on, and a resource management API that identifies and manages each of physical resources such as a terminal, a device, an article of commerce, a building, a place, means of transportation, and means of communication,

an event database device 52 that stores an event execution program, and log data generated during such event execution, a user database device 53 having user account information and so on, and a point database device 54 having information on points.

Further, it has an API registration processing unit 61 that receives an API according with a given API definition specification from an API provider terminal and registers it in the API database.

Additionally, it has an event creation processing unit 62 that transmits, to an event creator terminal, a given event definition specification and any API selected among APIs stored in the API database and receives, in the event creator terminal, an event execution program created by making an API received in accordance with the event definition specification be a component thereof.

It has an event registration processing unit 64 that determines whether the created event execution program accords with given criteria for feasibility in the present system and registers, in the event database, an event execution program that has turned out to accord with the criteria.

It has a communication processing unit 65 that transmits information necessary for or related to event execution to and receives it from event participant terminals, through a network.

It has a point management unit 66 that manages points or titles as interests granted by administrator users to ordinary users. Here, the points have pecuniary worth, for example, in such a manner as they can be converted into electronic money, while the titles have honorary one.

It has an event participant participation processing unit 67 that on the occasion that an event is being implemented, processes a matter of event participants taking part in the event.

It has an event participant interaction management unit 68 that manages interaction between event participants taking part in events.

It has a user behavior confirmation unit 69 that confirms behaviors of ordinary users taking part in events.

The management system according to the present invention is described below mainly with a specification of a computer program to be, in the case where to constitute it by connecting a server computer with user terminals through the Internet, mainly installed to the server computer.

FIG. 1 is a diagram to show a structure of a scenario. The scenario refers to scenarios of events, for example, such as a stamp rallies and group tours, which are created by event creators and taken part in by event participants.

BUIB in FIG. 1 is an abbreviation of Business User Interface Block. Here, a business user is an event creator. A user interface block is an element constituting an event execution program. The user interface block and a program block (PB) constitute the event execution program.

Inclusive type denoted on the upper left side of FIG. 1 means an inclusive BUIB. The part surrounded by a broken line on the left side of FIG. 1 represents an inclusive function sheet while the part surrounded by a broken line on the right side of FIG. 1 represents a model figure of a BUIB process.

The inclusive function sheet includes a plurality of BUIB processes, a trigger, a response, a constraint, an attribute/PB module, and so forth. A plurality of transition arrows is depicted to connect them. The transition arrows represent process call relationships between blocks. They can also be said to represent data input/output relationships made by adding timing information to member information.

When an API is one other than a GUI, it has a form in which transition opponents are depicted as argument. Which falls under a calling side depends on how implementation is made. Within event evaluation steps simultaneous processing is made at the time of evaluating steps.

A time zone manages time by comparing current times and time information processed through TZ transition. The TZ transition is a transition arrow denoted as “TZ.” The TZ means a time zone. The time zone is an object used to manage time elapse and timing for an event and to manage lives for contents disposed inside.

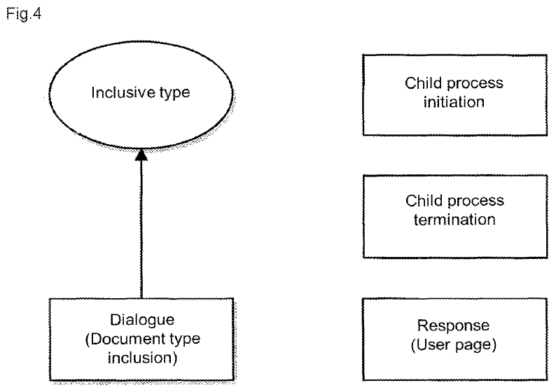

A portion denoted as ⋆001 is present on the upper left side of the inclusive function sheet. This means that “when the function sheet is opened, a wait reception starts for a child process.” See FIG. 4 for the child process.

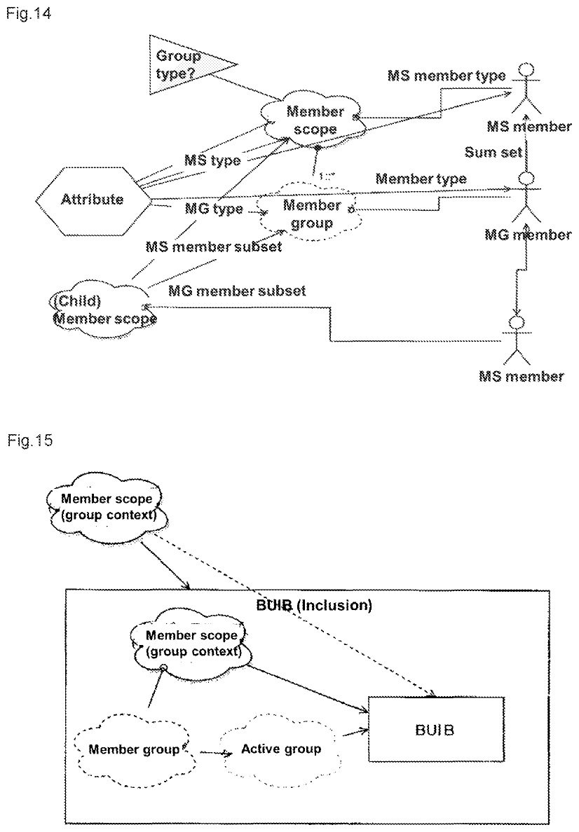

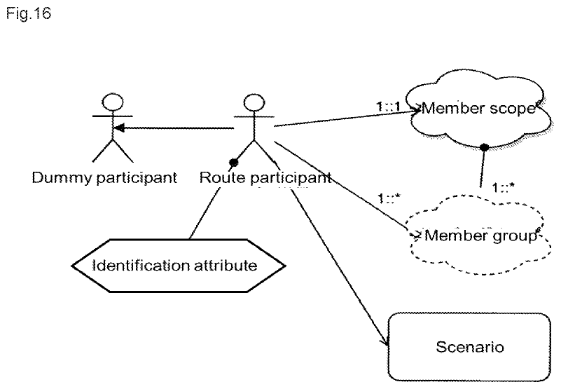

What is denoted as MS for abbreviation means a member scope. According to FIG. 1, it is a member scope (group context) that gives the inclusive function sheet a member scope constraint. An internal attribute reference context is granted by the member scope constraint (MS constraint) included. In addition to constraints on internal BUIB processes, a context is granted (though in the case where that attribute is used). See FIG. 14, FIG. 15 and FIG. 16 for the member scope.

The model figure drawn on the right side of FIG. 1 for BUIB processes represents one example of the BUIB processes. Once transition to the BUIB header occurs in accordance with a program block (PB) evaluation range, a series of processing processes are executed in the order of a processing step, a non-header standby, a processing step, a content, IF, a processing step, a processing step, non-header standby, and footer. An exception processing from the content and a NO-case processing from IF are also depicted.

Here, the header at the uppermost and the start block for the scenario are identical with each other.

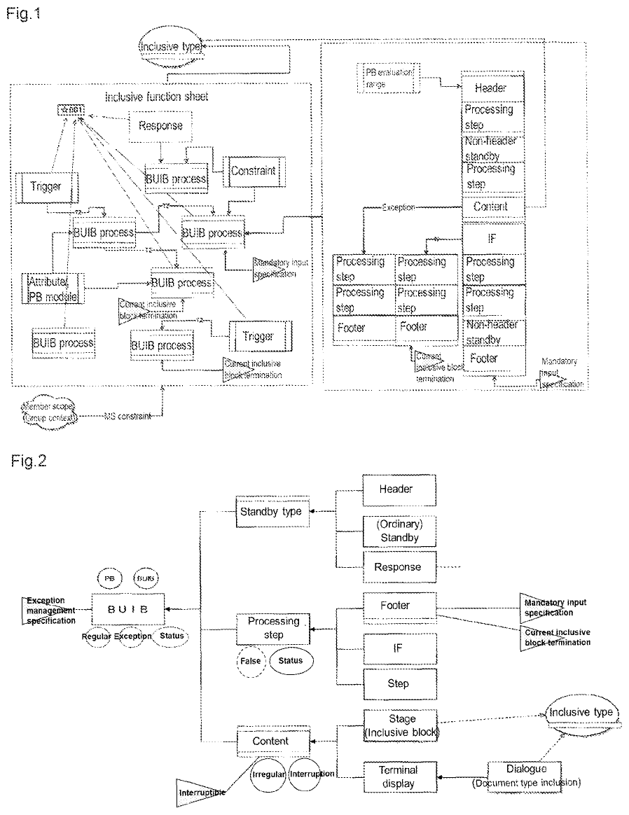

FIG. 2 is a diagram to show a BUI function model (Base layer-A control unit with no graphic element). As for wait reception and interrupt occurrences, adjustment is also made for interrupt processing in an inclusion block. Interrupts are managed in such a manner as running, after disintegrating a process into transactions, an IF sequence at the time of an IF cycling for a scenario alone or each of the inclusion blocks, or occurrences of system events such as a trigger, an alarm and periodical cycling. It is also taken into consideration to insert priority conditions or a process of notifying a participant of a trigger.

A BUIB process is dendrogram having divergence with its header at the head, and each of its branches needs to end at the footer.

A series of the BUIB processes that accept no interrupts are called transaction. A standby-type one accepts interrupts only in its wait reception. A response means acquisition of events via participant users' terminals, events on application screens, field zone state transition, users' check (between users or on devices). Here, a field zone is used for managing lives for contents associated with management of movement.

In FIG. 2, Status in Processing step is for managing a termination exception status. A sequence for the Processing step accepts no interrupts. Footer of the Processing step accepts a wait reception after termination.

Content accepts interrupts before starting and after starting. It is determined on the basis of properties whether to accept the interrupts while Inclusive type is being run (No discontinuation is made).

The Inclusive type makes an existence management for a child process and a termination management for an internal process as a whole.

Dialogue is a display having a child process.

A response UIB that receives an event being displayed can be disposed. Additionally, processing is made in accordance with such a disposed response.

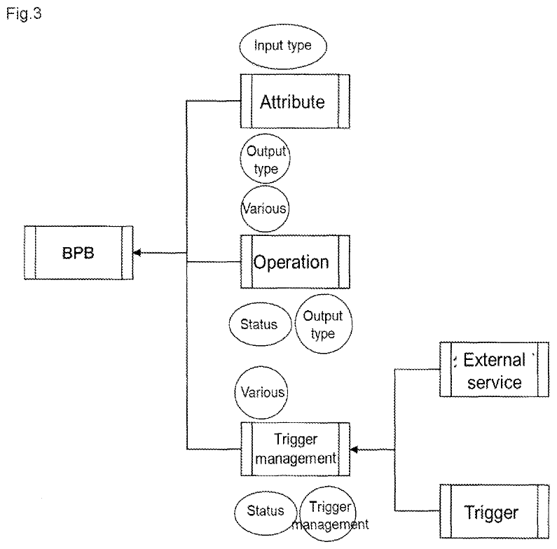

FIG. 3 is a diagram to describe a business program block (BPB).

Attribute returns a value newest in transition hour, and Default in the case where conditions are not satisfied.

Input type and Output type differ from each other in some cases.

Operation is, basically, identical in type information between an output value and an assignment value.

Trigger management output entails a standby judgement by whether true or false, or a numerical value counter, for controlling trigger timing.

FIG. 4 is a diagram to describe an inclusive type.

As for a child process, a header gets into a wait reception state once an inclusive BUIB is initiated.

As for Child process termination, firstly, the child process is closed when it gets through an inclusion block termination footer (internal process termination) whereas it terminates irregularly in the case where it has not gotten through a footer specified as being necessary to be inputted. Secondly, it terminates as a whole process in the case where the inclusion block has been through a discontinuation transition. Thirdly, termination processing is carried out for each time of transaction for interrupts.

Response, which is disposed in a child process of Dialogue, returns Status in the case where a corresponding event occurs in a parent display. It associates the event by using a tag or the like generated when it is disposed.

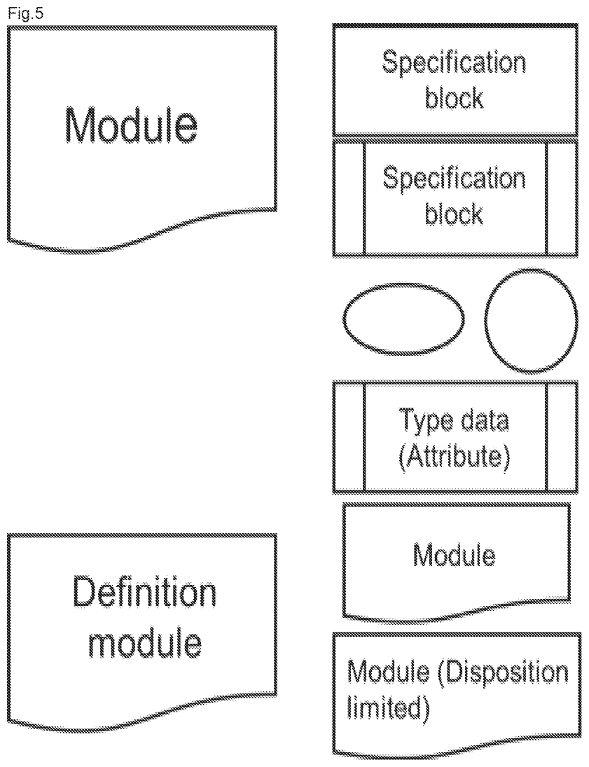

FIG. 5 is a diagram to describe a module.

The module is a set of blocks. It is understood to be in a shape of one (functional) sheet. Blocks in different sheets cannot be selected. However, it is thought that if an inclusion block is specified, it includes an internal process.

As for the modules, such ingenuity is made as modules identical in name can be identified.

It is module input/output that is denoted with an ellipse or a circle. The module input/output amounts to whole input/output with input/output between specification blocks, excluded.

Type data made to be a specification block has a property of being global (with respect to a module) or local (with respect to the module). Type data specified as global has its value shared. Type data specified as local has its scope within a module and has its value retained for each activated modular instance.

The module can be expanded as a function anywhere on a scenario. Modification made to the module applies to all modules expanded.

The module can have a property of forbidding a module defined internally to be disposed externally. This can prevent an imported module from excessively referring to global type data.

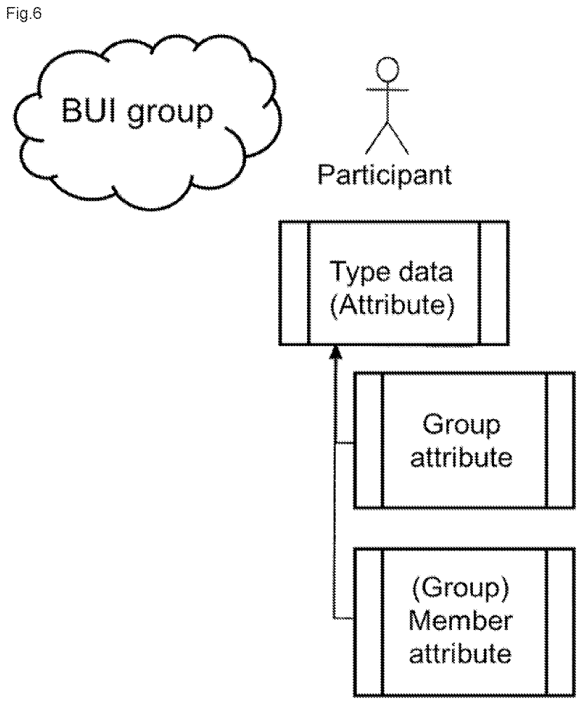

FIG. 6 is a diagram to describe a BUI group.

The group can have its participant belong thereto as its member. A scenario participant who has participated in a group shall have a membership for the group. The group can define type data as a group attribute and needs to choose, when defining it, a group attribute or a member attribute as a property. Type data for which attribute definition has been carried out between a plurality of groups has a value for each of them.

The group attribute has one value for each group object and can be referred to and operated by a participant having the membership.

The member attribute has one value for each of memberships of the participants and can be operated by only a participant having the relevant membership (the block instance thereof).

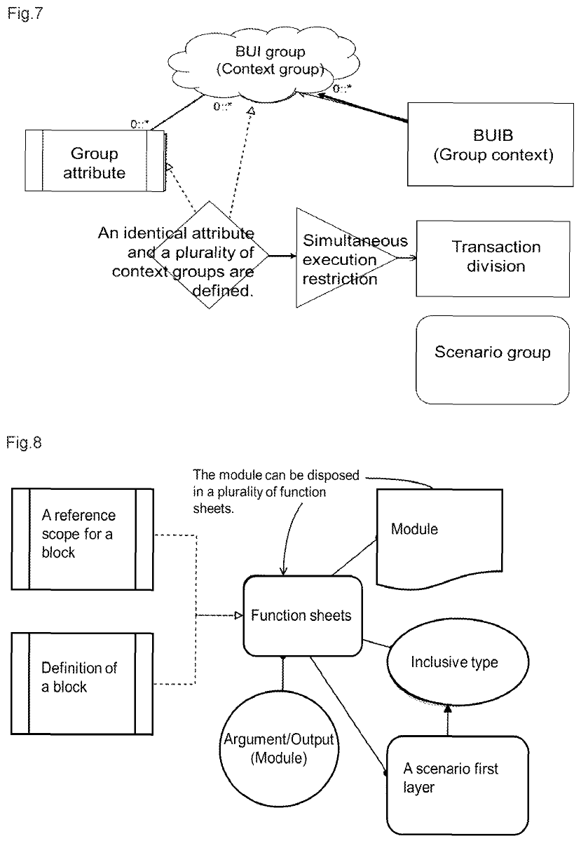

FIG. 7 is a diagram to describe a BUI group (group context).

Some BUIB can define one or more BUI groups as a group context. As for an attribute of a PB (program block) evaluation range of the BUIB, an attribute value for a group and membership that have been through the attribute definition is referred to.

Further, the group context can be also defined for a series of processing statements within a scenario in which a participant as a processing target needs to be specified, such as an event evaluation step and a BUIB process. As a result, even without defining, on an interaction between participants who have utilized a value and/or attribute common between group members or in a group, relevance for each of the attributes, smooth statements can be made without any contradiction only by specifying a group as a processing target (for which relationship to the attribute has been defined).

In the case where an identical attribute and a plurality of context groups are defined, no error is entailed thereby and a transaction including that BUIB is replicated for each of BUI groups that collide with each other in an attribute reference and is then divided as an interrupt process. Execution of a group that has caused the division as conditions for executing transaction is controlled under interrupt conditions (A higher layer determines what kind of conditions should be actually taken in).

The above processing is accomplished by simply carrying out parallel processing, when the transaction does not include any processing occupying participant terminals. In view of implementation, it is accomplished by processing a member scope as an active group.

Every scenario participant has scenario group memberships by default.

FIG. 8 is a diagram to describe a reference scope and a function sheet for a block. A whole set consisting of a process of a scenario first layer, a child process of an inclusive type, a specification block for a module and the modules is referred to as a function sheet. The blocks can refer to each other only within such a scope. Although the sheet is substantially identical to a sheet on a UI (user interface), the former shall be distinguished from the latter (because a plurality of function sheets such as domain modules and inclusion blocks is likely to be merged with each other).

Additionally, the blocks are defined by a function sheet that has been disposed. Only an object that has been modularized can have instances disposed on a plurality of function sheets. It depends on a global property for type data whether values for type data or the like are globally retained.

For the inclusive type, an object specified as a module by default can be specified as well. It is an object to be presupposed to be used in a participant attribute and/or a plurality of function sheets.

Although the modules are not in any nest relationship with each other by default regardless of where they have been defined in the modules, they can have disposition limitation placed on through a property for the module (A nest relationship can be also defined thereby.).

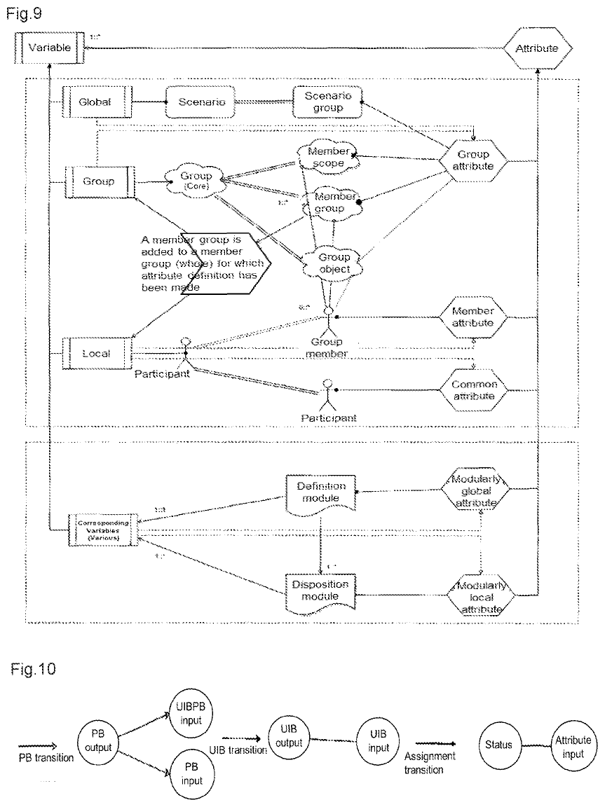

FIG. 9 is a diagram to describe a variable and an attribute. The variable represents a function to save a value in a core process of the present program and includes a system variable and a variable that cannot be operated by a user while the attribute is a part that exhibits a function of a business user interface for the present program.

The attribute represents an attribute ancillary to a BUI object and is defined for each of objects as a scenario, a member scope, and a participant. In the case where the attribute is defined in an object (class), it has a value for each object instance and controls event progress while specifying a value to be referred to on the basis of a group context. Function of a global variable is taken on by an attribute that is a scenario group attribute and is modularly global. The attribute can be disposed anywhere and has one value for each scenario.

The meaning of an arrow being drawn from “A member group is added to a member group (whole) for which attribute definition has been made” to “Group” is that when a member group is added to a member group for which attribute definition has been made, a group variable corresponding to a defined group attribute is added.

The meaning of an arrow being drawn from “A member group is added to a member group (whole) for which attribute definition has been made” to “Local” is that when a member group is added to a member group for which attribute definition has been made, a local variable corresponding to a defined member attribute is added (activated for a member only).

Here, a member scope and a member group are defined on the basis of a group attribute and a member attribute, whereas a group object has no way of being directly defined and therefore, is controlled and managed by a member scope and/or a member group.

A part surrounded by a broken-line rectangle on the bottom part of FIG. 9 shows that attribution processing for member scopes and attribution processing for modules are in parallel with each other.

An arrow from a definition module to a corresponding variable means that when a module including an attribute is defined, a variable is added.

An arrow from a disposition module to a corresponding variable means that each time that a module including an attribute is disposed, a variable is added.

FIG. 10 is a diagram to describe an evaluation range of a UIB (user interface block). PB (program block) transition is realized as an input from PB output into UIBPB (user interface block program block) or a transition from PB output to PB input. UIB transition is realized as a transition from UIB output to UIB input. Assignment transition is realized as a transition from Status to Attribute input.

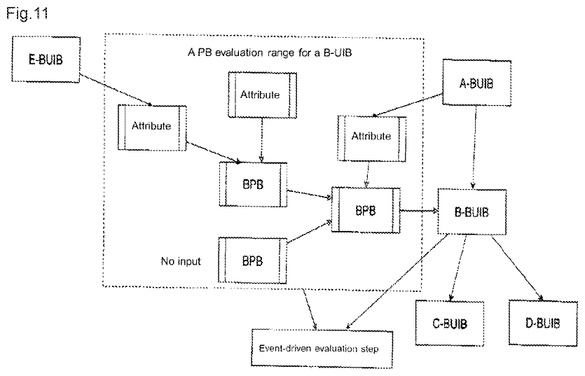

FIG. 11 is a diagram to describe a PB evaluation range of a B-UIB.

An evaluation range is a counterpart of a line in a statement computer program. It carries out calculation, display, responses, and trigger processing for users by using attribute information at the time of a step evaluation. Additionally, a next evaluation destination can be varied in accordance with that result. (As a graphical expression, processing is disposed outside a step standard icon in some case and is disposed inside it in another case).

In an embodiment example, a BUIB that has been through UIB (user interface block) transition sends processing request information to a BPB (business program block) through PB transition, processes a terminal BPB when the information reaches a BPB lacking attributes or input, and then returns an output value. A BPB to which the output value has been returned carries out processing when all inputs are complete and then returns an output value. Lastly, an evaluation is returned to a BUIB and processing is carried out for the BUIB.

An attribute value refers to status information for an assignment source when receiving an evaluation request and then returns a newest assignment value or a Default value.

With respect to functions, the embodiment example allows no algorithm except for that of a call relationship to be provided, but allows a function that has been realized in a structure of controlling an evaluation step, such as iteration and condition-dependent processing to be incorporated (In view of the definition, no standby function is not allowed to be provided in processing a scope internally.). On the occasion of evaluation, not only assignment but also ordinary BPB processing can be allowed to be provided so that evaluation step processing is flexible (In this case, output=processing request).

Otherwise, a PB scope within which to carry out processing can be specified in advance so that the processing is allocated thereto, or processing request can be separated from input/output so that it is an instruction for a single PB.

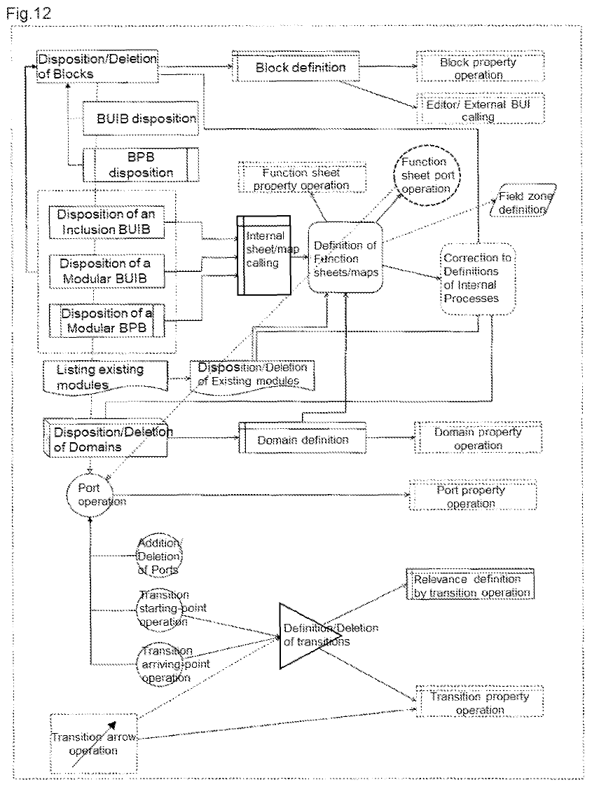

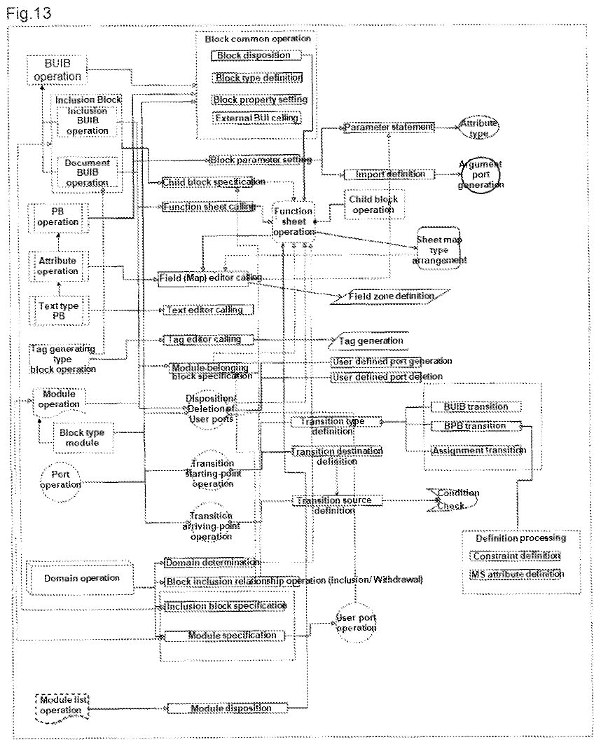

FIG. 12 is a diagram to describe a BUI (business user interface) function model—an editorial operation model (partially taking a GUI into account).

GUI (graphical user interface) function operation is function operation that should be rendered by a GUI. Operation in a function model can be reduced to this. On the other hand, GUI operation itself consists of GUI function operation and graphical expression operation.

A port is added/deleted in an internal disposition of a specific block or in a port disposition portion of a block.

It is also allowed to handle a transition arrow as a function object.

FIG. 13 is a diagram to map model function operation.

It is mapped by extracting function model operation in accordance with GUI function operation.

As for calling an external BUI in operation common among blocks, that which is an external module and is provided with its own property definition management UI can be called.

“Transition type definition” is somewhat fixed depending on a port type and a transition destination.

An internally defined module is automatically registered in operating a module list.

FIG. 14 is a diagram to describe a BUI function model (Practical layer-A control unit with no graphic element).

A member scope is a function model to dynamically control a group function, and is basically a set or array of groups, a group belongs to which is referred to as a member group. In a scenario statement, the member scope is stated as a processing unit and no direct instruction is stated for the member group, basically. Instead, a group to be processed is specified by a group context such as an active group instruction, and a set composed of PBs (functions), and operation related thereto. This allows a participant group that has been generated ad hoc within an event, to be dynamically processed.

A member scope (MS) can have a plurality of member groups. The MS itself has a group constituted by members in a sum set of all members of a group. Additionally, the MS has a property as either of a group and non-group types in which members in a member group are exclusive of each other.

The member scope can have, instead of a member group, another member scope as a member group. It follows that an MS member of a child MS is a member of a member group.

For a member scope, an attribute can be defined as type data. It can be classified into three (four) types of a member scope type, a member group type, a member type, (an MS member type) depending on what is intended to have an attribute value. For an attribute that has been defined as an MS, a plurality of types cannot be set and cannot be an attribute of another group or an MS.

A member to manage a member scope and a BPB (business program block) to add/delete a group and to control an active state are present.

A member scope (MS) can be defined as a child member scope of another MS. In this case, members of this MG (member group) constitute a subset of members of a group to be defined by a parent.

For definition, whether to be defined for an MS group in the same way as attributes are or to be defined as a subset of an MG group can be chosen. (If the subset of an MG is chosen, it follows that an MS instance is generated for each of the MGs).

In the case where nothing is defined, a non-modularly global member scope defined within an inclusive function sheet that has been subjected to MS constraint defines an MG member subset for a constraint MS. A modularly global MS is deemed as an independent MS in the case where it is not defined in terms of relevance.

Within the MS constraint above, attribute constraint is inherited by the inclusion inside.

FIG. 15 is a diagram to show that a member scope gives a group context to a BUIB. A member scope can give a group context to a BUIB. By a member group belonging thereto, an actual context is given.

A BUIB whose group context is defined by a member scope that has been through transition executes only an active group.

All member groups in an MS of a BUIB that gets through transition for the first time are basically active. An active group flag vanishes once the group is executed. In the second transition or that after it, an active group is granted to a member group newly added in the first or that after it. This is a basic specification, and in some case, all groups get active for every transition and in another case, an active group is specified by operation through PB.

Control by these active groups is executed since in the case where a group being generated ad hoc as an event goes on has been incorporated, a participant that overlaps each group of a member group constituting a member scope is likely present. Definition that excludes overlaps between memberships of member groups can also be made (the statement of “Group type?” in the upper part of FIG. 14 shows that property).

A group context of a higher BUIB is granted to a child BUIB of an inclusion block. In the case where an attribute defined for a higher member scope is used by a child process, an attribute value is referred to in accordance with that group context.

FIG. 16 is a diagram to describe a system setting attribute.

A BUIB whose group context is defined by a member scope creates a dummy participant (a route participant). A route participant that exists only for a BUIB execution period is created in each of MSs and group members. A special attribute is allocated to that.

A statement that is not executed if it would be a usual statement shall be inserted. The statement can be used for a statement inside a block in the case where the block is inclusive one.

Additionally, a dummy participant is created as a concomitant, in a scenario (group) as well. This is because in the case where a group attribute is processed, confusion is likely to occur about a number of times of execution if a participant statement is made with a group condition accompanied, so that the statement should be allowed to be made as a process to transact another attribute.

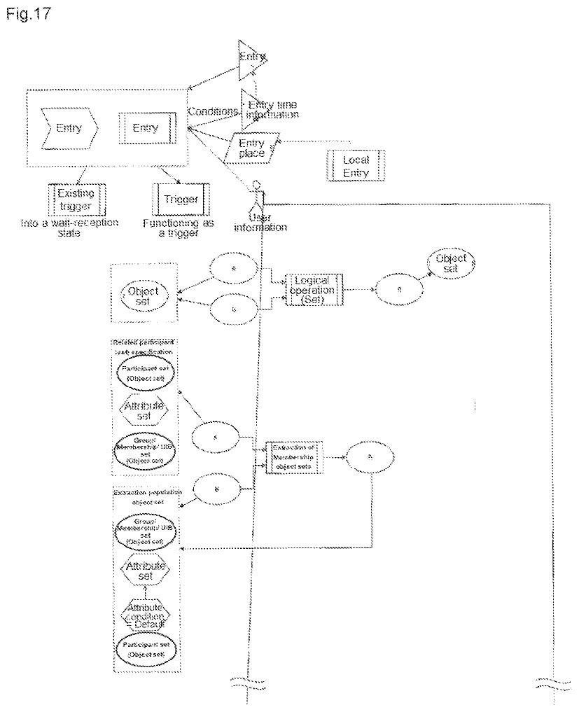

FIG. 17 is a diagram to describe an entry condition definition and a related participant specification (Part 1).

Entry function has its realization block disposed in a process of another participant including a route participant, and generates entry information after the block is allowed to wait reception, with a reception location, user information, and entry hour information being conditions.

It works as an interrupt UIB or a PB trigger.

Additionally, when it is generated, it keeps, since then, a trigger in a disposition sheet and in higher inclusion, which is a trigger that can get into an internal standby state, into a standby state. Local entry in FIG. 17 is an event entry on which field zone constraint has been imposed.

As for logical operation for sets, a member scope makes, in a logical handling between logs, exit MSs, and ex-MSs, operation be executed between the groups corresponding thereto.

As for a related participant (set) specification, firstly, a participant set (object set) extracts a UIB having members of the participant set as its current members by logging or specifying them Secondly, an attribute set extracts a B in which the attribute is defined as a related attribute for the B. Thirdly, a group/membership/UBI set extracts a B having a relationship (a parent-child relationship or a context group/MS relationship) to its object set.

B is the “B” denoted in FIG. 17.

As for an extraction population object set, the attribute condition is that an attribute of having a value other than a Default value in members of the participant set should be extracted.

As for membership object extraction, defaults should be determined on which to indicate a member set or to indicate an object in the case where an object having a membership is inputted to an A.

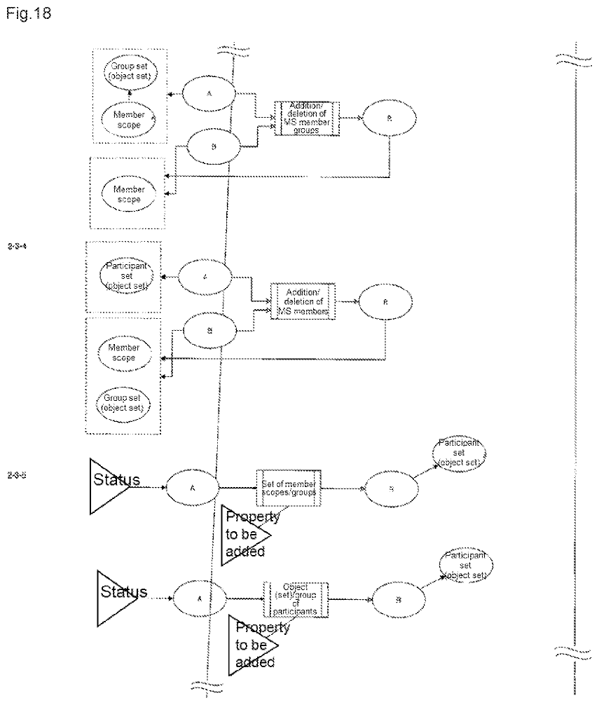

FIG. 18 is a diagram to describe an entry condition definition and a related participant specification (Part 2).

As for MS member group addition/deletion in the uppermost part of FIG. 18, a group inputted through A is added or deleted as a member group of a member scope inputted through B.

Assignment output is a newly composed member scope.

In the case where no B is present, it is generated as a new member scope.

As for MS member addition/deletion in “2-3-4” of FIG. 18, a participant set inputted through A is added or deleted as a member of a group inputted through B.

B: Member scope (non-group type)>> A participant set joins every group as a member.

B: Member scope (group type)>> A participant set is added as a new member group.

B: Group set (non-group type)>> A participant set joins every group as a member.

B: Group set (group type)>> No processing is carried out and a False value is returned.

Assignment output is a newly composed member scope and/or group set.

In the case where no B is present, it is generated as a new member scope.

A property to be added to a member scope/a group set is specified not as an assignment but in a way of a member being added as a new member group, in “2-3-5” of FIG. 18.

A property to be added to a participant object (set)/a group is specified not as an assignment but in a way of a member being added to a storage value, in “2-3-5” of FIG. 18.

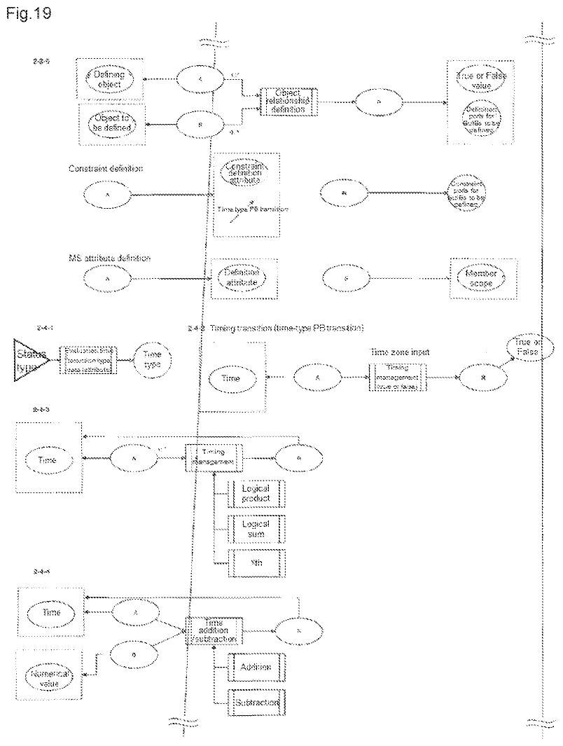

FIG. 19 is a diagram to describe an object relationship definition, a constraint definition, an MS attribute definition, and timing transition.

As for Constraint definition in “2-3-6” of FIG. 19, a B port and a parameter are used in the case where condition comparison comes in.

Evaluation time retention type data (Attribute) in “2-4-1” of FIG. 19 has a future value (or a value requiring special processing to call a Default value) by default. Additionally, time-type ones get through assignment transition and retain final evaluation time as a variable value. Output is time-type one.

In Timing transition (Time-type PB transition) in “2-4-2” of FIG. 19, timing management (true or false) is carried out in a manner of returning False in the case where A is a future time as compared with current time while True in the case where it is a past time.

Timing management in “2-4-3” of FIG. 19 is carried out by paying attention to transition timing.

Firstly, an argument in the future as compared with current time is ignored (In the case where all are future time, the future time is returned).

Secondly, if arguments to be ignored run out, newest time is returned (logical product). Thirdly, if transition occurs even once or more in the past, an earliest time thereof is returned (logical sum). Fourthly, a response is made to Xth as in the third case.

In Timing management in “2-4-3” of FIG. 19, timing management for a given standby BUIB is carried out on the basis of evaluation time information. For this purpose, it should be carried out by receiving assignment output of a block or trigger related thereto by evaluation time retention type data, through an evaluation by a time management type PB therefrom, and finally by a timing management BPB (true or false) type one.

As for “Numerical value” in “2-4-4” of FIG. 19, a numerical value-type one is increased or decreased to a time-type one and a specific time value is calculated.

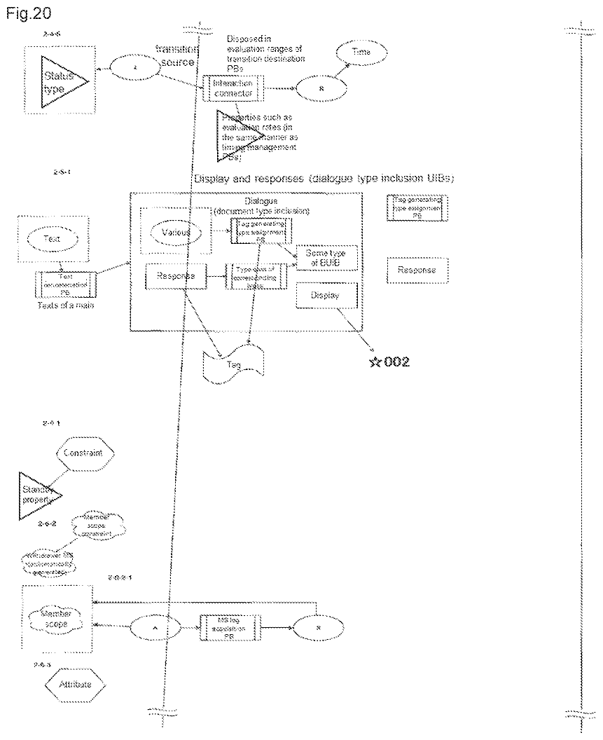

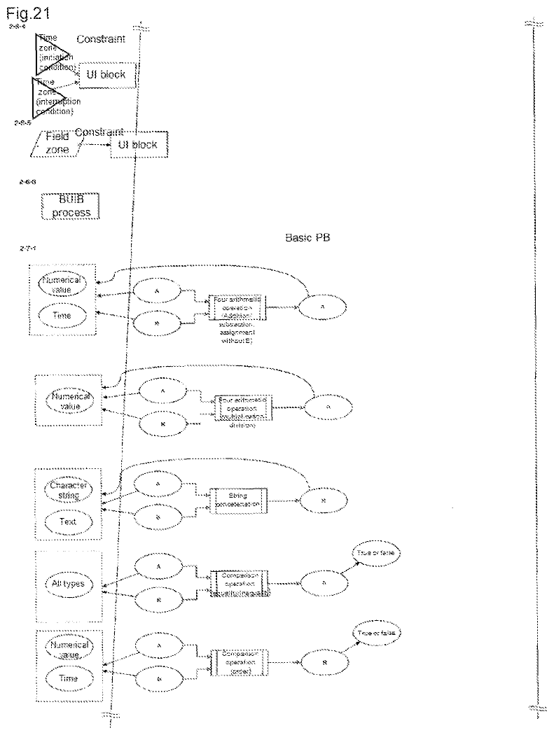

FIG. 20 is a diagram to describe an interaction connector, display and responses, a constraint, a member scope constraint, MS log acquisition, and an attribute. Interaction connector in “2-4-5” of FIG. 20 denotes a type data type PB. If it obtains evaluation time information and group information on a transition source, and satisfies conditions when transition occurs in a group as the transition source, it returns an evaluation time to a group as the transition destination (a future time on the occasion of Default). In the case where B input is not defined, determination on whether collective conditions are satisfied in a transition source that has been evaluated can be made on Properties and can be made after the conditions are calculated by another PB (program block), in a transition source PB evaluation range, with a logical sum being set.

Tag generating type assignment PB in “2-5-1” of FIG. 20 generates a tag to be associated with a text to be displayed when it is disposed in a parent node, and renews and displays the information at the time of PB evaluation, at a location at which to locate the tag. By the time when a parent block is initiated, the PB is evaluated at least once.

Response in “2-5-1” of FIG. 20 generates, if disposed there, a tag associated with a text to be displayed and, when an event occurs at a tag disposed on a text, returns information corresponding thereto and renews a status.

Dialogue (Document type inclusion) in “2-5-1” of FIG. 20 has an evaluation process of input/output information, stated therewithin. ⋆002 in “2-5-1” of FIG. 20 means that “a display UIB disposed inside generates another screen.”

That an arrow from Tag generating type assignment PB to Tag and an arrow from Response to the Tag are denoted in “2-5-1” of FIG. 20 means generating, if the Dialogue is disposed, a tag associated with a parent block (texts of a main).

With regard to Constraint in “2-6-1” of FIG. 20:

Constraint is intended to typify participant memberships including time, location, and attributes and to allow each process to be defined, in order to simply organize context conditioning for a series of processing in which a series of contexts are similar to each other. This allows, by stating attributes, member scope, location at which to provide a service, and processing for each time in parallel on a function sheet and associating relationships therebetween with time zone transition and so on, a scenario to be stated as a dialogue or a chat for each of scenario participant types. Not only ordinary participants but also devices and appliances that communicates with the ordinary participants at sites can be seen as participants and an interaction involving devices can be definitely identified especially at the stage of stating service processing.

1: Constraint functions as conditions for initiating a block. Specifying Standby property makes a standby-type one, which waits reception until overcoming all constraints (having established even one or more member group in its member scope) after receiving initiation UIB transition. Although this property is in a lump by default, it can be set individually. In the case of a non-standby state, the block is skipped unless the conditions are satisfied.

2: Constraint functions as exception conditions. If even one or more constraint conditions fail to be overcome, interruption occurs and a block is terminated. In the case where an MS constraint is on, the property determines whether all groups terminate or only the participants exit.

3: Elements that can be specified as conditions are limited for each.

Member scope constraint in “2-6-2” of FIG. 20 specifies one member scope object. A BUIB specified is a context group.

As for MS log acquisition PB in “2-6-2-1” of FIG. 20: While an MS constraint block is being executed, a property of stopping an active group member from being changed can be specified. In the case of permitting a member to be changed, a withdrawer MS that allows a joining/withdrawing member to be specified is automatically generated.

Additionally, a log acquisition PB is created in order to calculate difference between members.

As for Attribute in “2-6-3” of FIG. 20: The attribute condition is that one or more attributes can be specified (logical product). Conditions by attribute values can also be specified. If-type attribute conditions are specified by a PB. A group of member scopes that specify group contexts can also be specified on the basis of conditions and so on (the conditions specified).

FIG. 21 is a diagram to describe a time zone constraint, a field zone constraint, BUIB process, and a basic PB.

Time zone constraint in “2-6-4” of FIG. 21 is an initiation condition and an exception condition in terms of time. For an inclusive one and a standby-type one, conditions are defined for the two, (wait reception) initiation and interruption (standby termination) and are usually for initiation only. They need to be specified by a true or false type timing management PB.

Field zone constraint in “2-6-5” of FIG. 21 specifies one field zone. For the filed zone constraint, field-in is the initiation condition, and when field-out occurs, interruption ensues.

In BUIB process of “2-6-6” of FIG. 21, a member scope, attribute, field zone constraint in a header affects the whole. In the case where the constraints change individually, a logical product condition holds true. In that case, the standby property for constraint is, by default, that the header stands by and that a block in a process is skipped.

In String concatenation in “2-7-1” of FIG. 21, it is desirable that a method of concatenating different-type texts through format synthesis is also available.

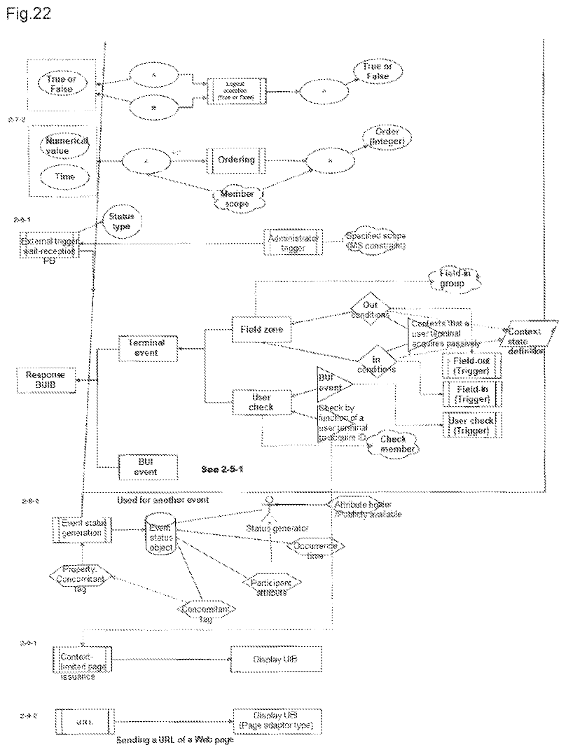

FIG. 22 is a diagram to describe order calculation, an administrator trigger, external trigger wait-reception PB, a response BUIB, event status generation, context-limited page issuance, and URL issuance.

As for Ordering in “2-7-2” of FIG. 22: An order is calculated from value-type, time-type attribute information on members and member groups and is assigned to a value.

No identical rank is present. A specification in which recalculation can be carried out at the time of renewing MS constitution is desirable.

As for Member scope in “2-7-2” of FIG. 22: It is necessary to be group attributes or member attributes in an identical member scope.

As for External trigger wait-reception PB in “2-8-1” of FIG. 22: When a stated inclusion block is initiated, wait reception is initiated.

Ordinary output is a true or false, or a value (counter) type one for managing transition timing.

In “2-8-1” of FIG. 22, an arrow is drawn from “Administrator trigger” to “External trigger wait-reception PB,” and therefore, one that is intended for any member scope such as events on the Web is possible.

As for Response BUIB in “2-8-1” of FIG. 22: It is information that can be obtained by a terminal application or a browser.

For Context-limited page issuance in “2-9-1” of FIG. 22, a display UIB page that has been designated is made to be current and is subjected to a QR check or to a check by another vicinity communication means, and thereby, a check occurs in that context (trigger occurrence in a check that has been designated). When checks occur in pages different from each other, a system response to confirm such occurrence is opened.

URL in “2-9-2” of FIG. 22 means sending a URL of a Web page.

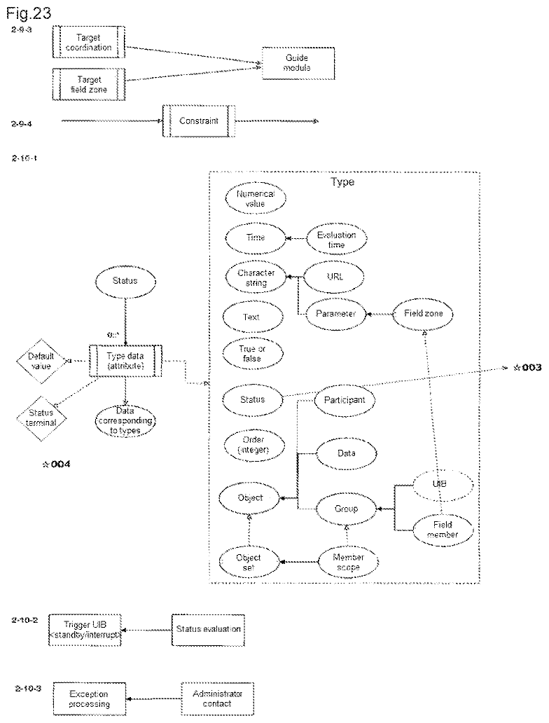

FIG. 23 is a diagram to describe the grant of constraint function to a connected UIB, and to describe status evaluation, administrator contact.

“2-10-1” of FIG. 23 describes the grant of constraint function to a connected UIB. Type data in “2-10-1” of FIG. 23 accepts a plurality of assignments and a value of a newest evaluation time (in order to realize function of a variable).

In “2-10-1” of FIG. 23, ⋆003 means that “a status-type one has a structure made of [a status-side evaluation time, an output name, a type, a value, (a group object)].”

In “2-10-1” of FIG. 23, ⋆004 means that “type data wherein no evaluation time is present (for all transition sources, evaluation has not been made yet or no assignment is present) has a default value, and a type data block limited to a status terminal in an inclusion block generates an output port outside the inclusion block, and a port issues a status each time that a type data is evaluated, and the breakdowns of the status is, Evaluation time: evaluation time on UIB evaluation range of a type data, Output name: names of evaluation data, Type: types of type data, Value: current values, Member participants on execution/belonging groups if on MS constraints.”

Status evaluation in “2-10-2” of FIG. 23 is function which is paired with a status terminal, in an inclusion block. If a status evaluation UIB is disposed, type information for exchanging types is specified as a property. Then, a PB evaluation transition port corresponding thereto appears outside. The outside port accepts a designated type and denotes a UIB name as an input name. Additionally, the status evaluation UIB has a status port to output its value.

Administrator contact in “2-10-3” of FIG. 23 falls under a display UIB or a document-type inclusion UIB and has function of calling means to contact an administrator.

Here, the administrator is an administrator of this event administration system.

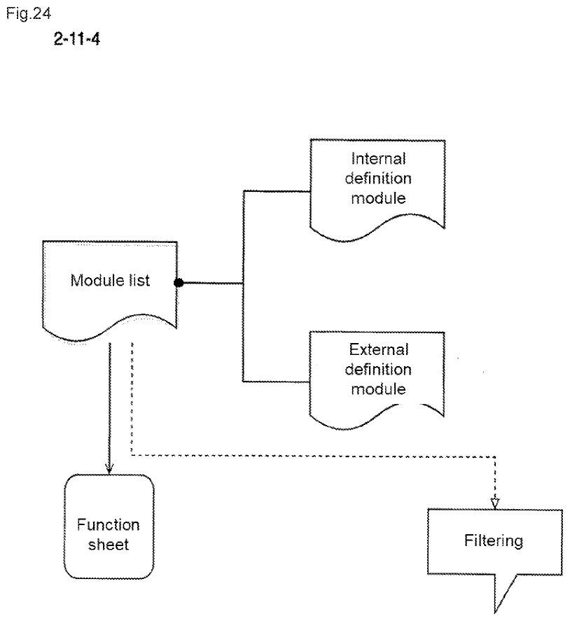

FIG. 24 is a diagram to describe a module list.

A module list is a list of defined modules. Not only scenario-inside definition but also external data is handled there.

An internal definition module is added to the module list when defined by any one function sheets.

An external definition module is a module defined outside which has been subjected to some import processing. An object taken from a participant attribute or a library on use is handled as the external definition module.

As for a function sheet, only one instance can be disposed in one function sheet. As for filtering, the filtering is carried out automatically by the property of a module through the restriction on browsing and is used as an alternative for ordinary scope function.

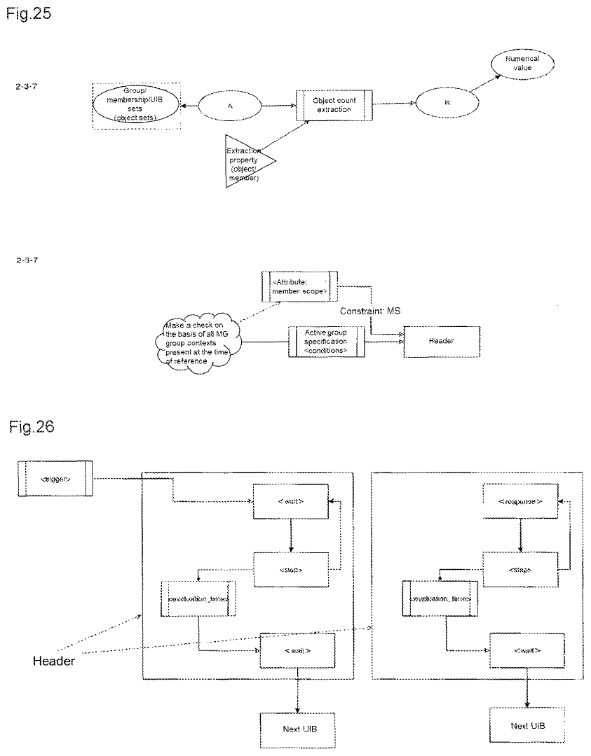

FIG. 25 is a diagram to describe object count extraction and active group specification.

Object count extraction is intended to extract an object element count or a member (participant) count of an object set of A.

As for active group specification: In the case where an active group specification PB is once connected with a header through linkage, default active group specification is initialized and checked.

FIG. 26 is a diagram to describe function of a header.

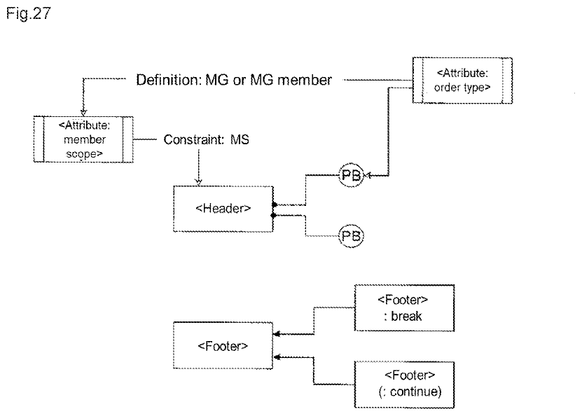

FIG. 27 is a diagram to show relationships between a constraint and a header or footer.

An order from <Attribute: Order type> to PB (program block) runs a sequence in the order of order attributes of an MG (member group) or a MG member.

Of PBs leading to Header, the lower PB is a Boolean and is a PB input port for terminating iteration, and terminates iteration at True value.

<Footer Break> terminates iteration run.

<Footer Continue> goes on with iteration run. Even if it is not stated, the same holds true.

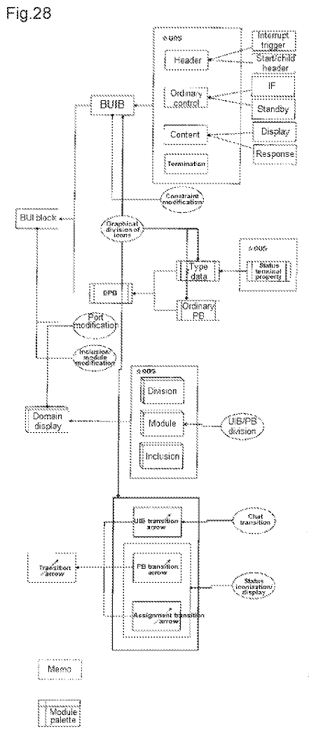

FIG. 28 is a diagram to describe a graphical unit (icons and palettes) of a BUI.

In FIG. 28, ⋆005 appears in three points. It means “a division in a block by making some line-drawing modification.”

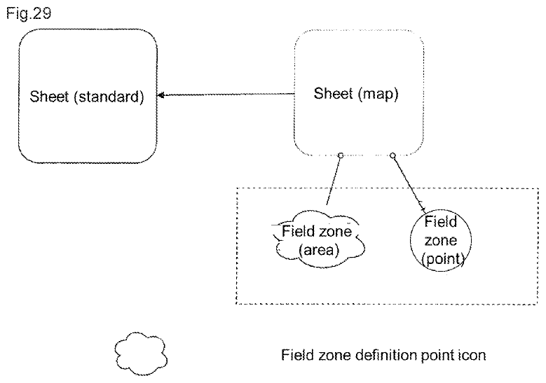

FIG. 29 is a diagram to describe a field zone definition attribute icon. Two figures surrounded by a broken-line rectangle is handled as such a field zone definition attribute icon.

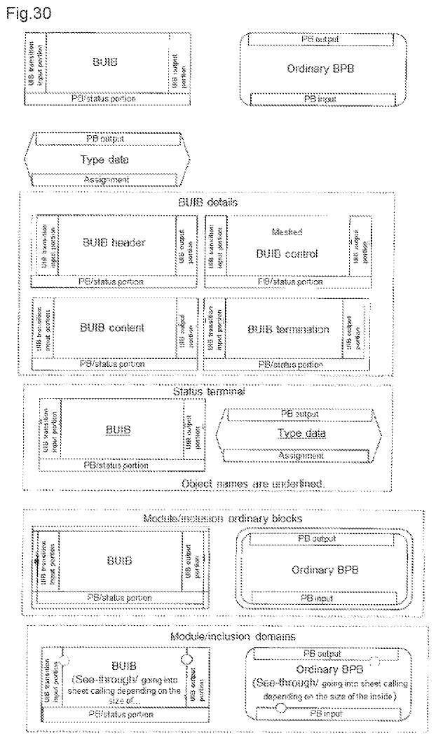

FIG. 30 is a diagram to show an example of division. Type data may be made so that it can be turned over between up and down, or right and left.

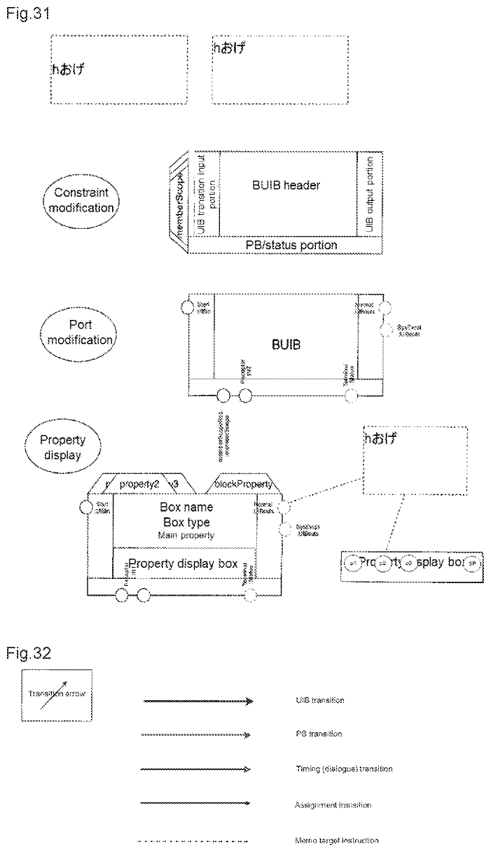

FIG. 31 is a diagram to show an example of division (sequel).

Two rectangles drawn by a broken line in the top of FIG. 31 (portions surrounded by a broken line) both means a simple domain or a memo. The memo can be made to be opaque.

A port is provided with a port name and a type name. Display is desirably allowed to be chosen from any of the outside and the inside.

In a method of display by a tab, information on properties such as a selected property tab or port is displayed on a property display box.

In the case of a method of display by memo linkage, property icons stand abreast in a property display box. When a memo domain is linked with a port or a property icon, a memo gets into a property display mode and information is displayed there on a relevant matter. A plurality of information memo can be disposed in the surroundings.

Whole information: A whole summary to be linked to a block property tab in a tab method whereas to a block property icon in a memo linkage is displayed.

Property alteration: When a portion for displaying property information or the ground of a box is clicked, a property setting screen for the whole appears.

FIG. 32 is a diagram to describe a transition arrow. Only an arrow of UIB transition shall be somewhat larger in shaft thickness. Time-type PB transition is distinguished from other types.

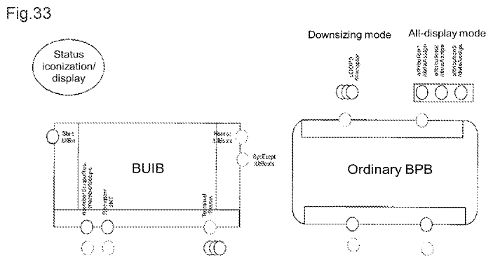

FIG. 33 is a diagram to describe status iconization/display. In a status icon, an opponent-box name and a port name are displayed.

When a mouse moves to a block with transition that has been subjected to status iconization, all of the status icons return to a transition arrow.

Usually in BPB display, when a mouse moves to a status icon, an icon of the port thereof returns to a transition arrow. When it is clicked, it shuttles between its all-display mode and downsizing mode.

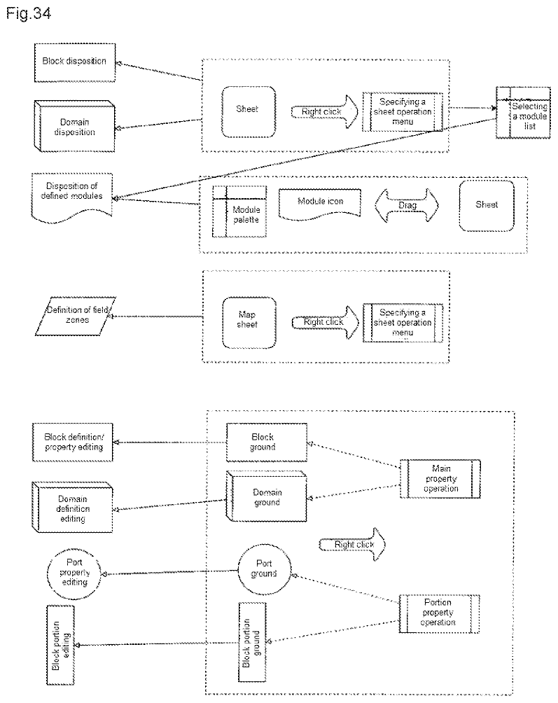

FIG. 34 is a diagram to describe graphical operations (related to function models) in an example of division.

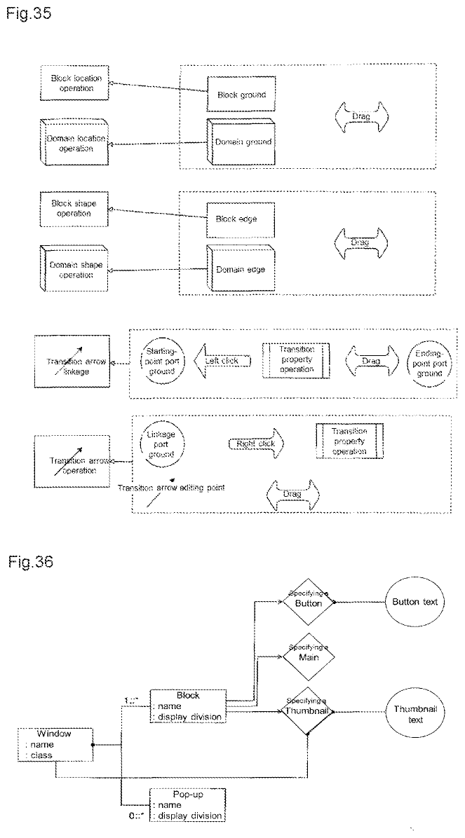

FIG. 35 is a diagram to describe graphical operations (related to function models) in an example of division (sequel).

FIG. 36 is a diagram to describe a display context specification tag. Windows, blocks, pop-ups are defined as (scenario) attributes. (The same holds for relevance definition).

Window+Name+Class

Block+Name+Display division+Belonging window (Belonging class)+Property+Instruction window+Text URL

Block+Name+Display division+Belonging window (Belonging class)

<<Embodiment Example: How to Brew Chinese Tea Tutorial>>

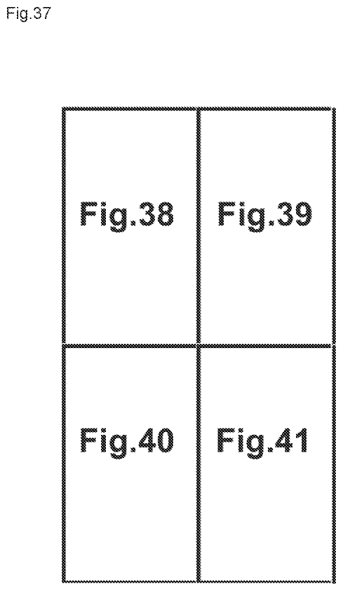

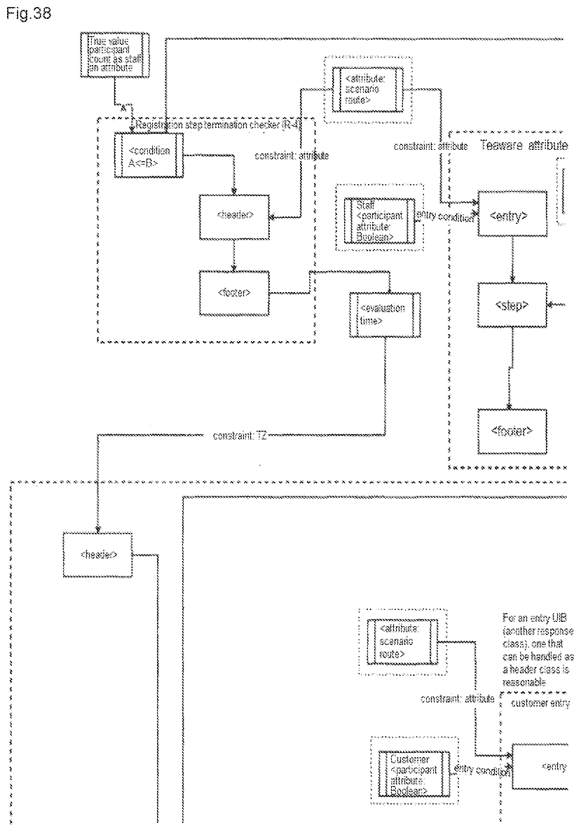

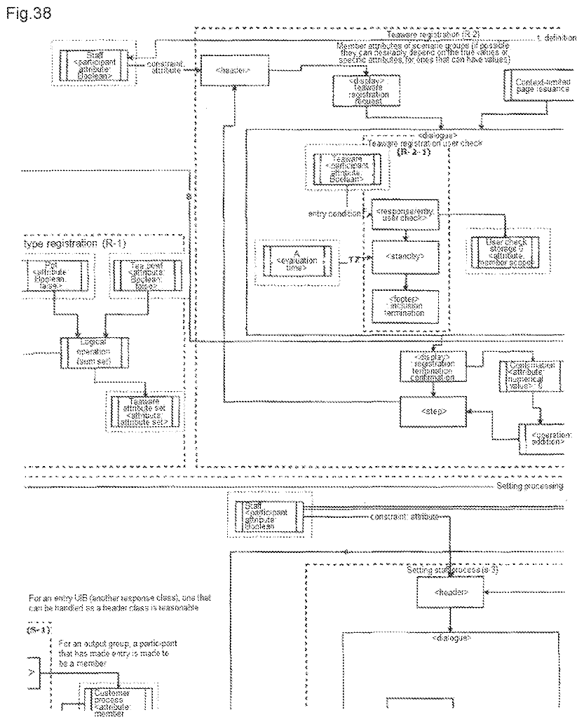

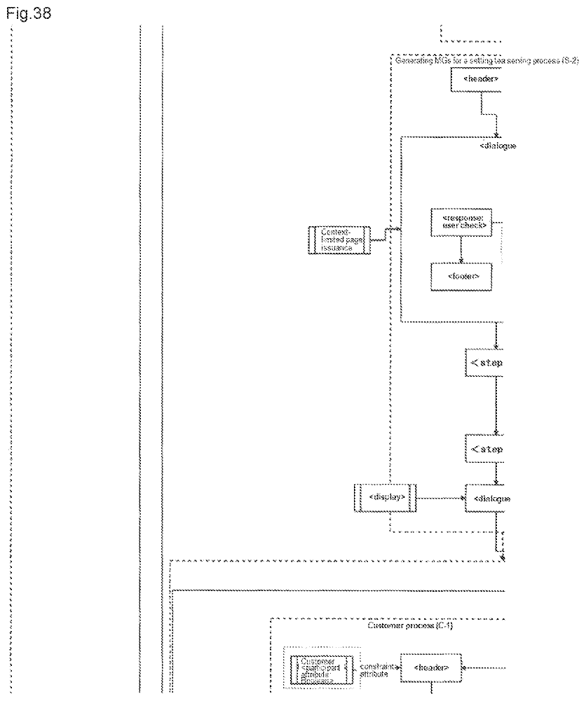

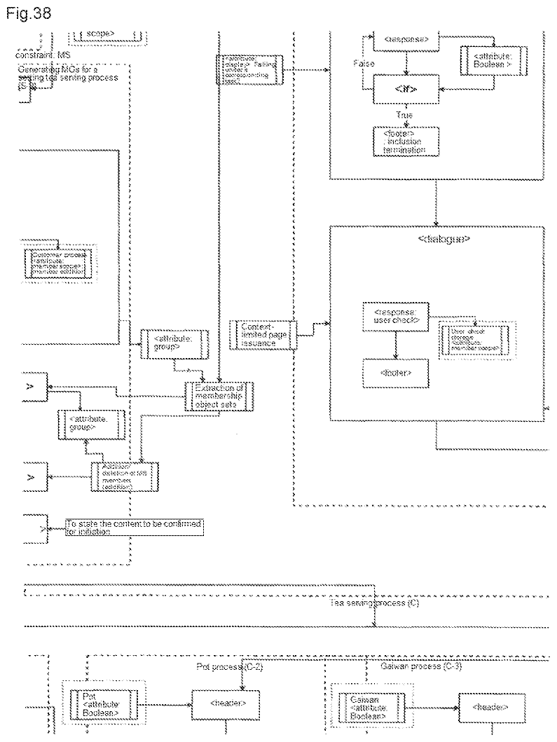

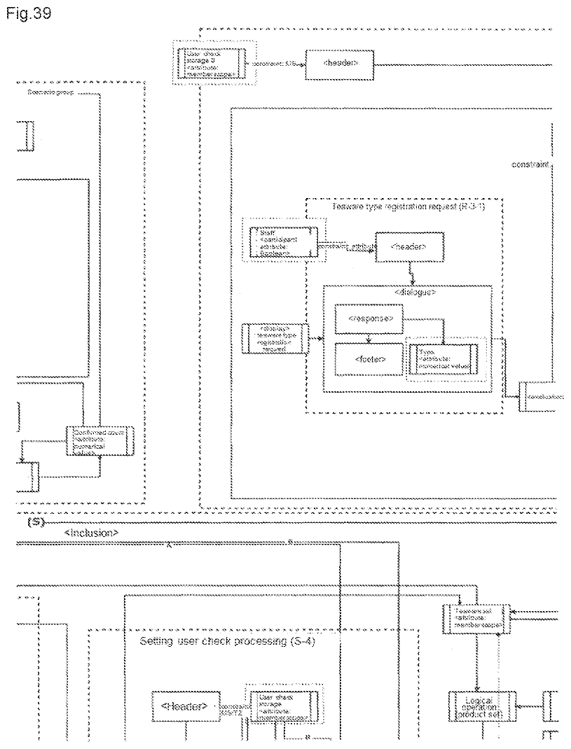

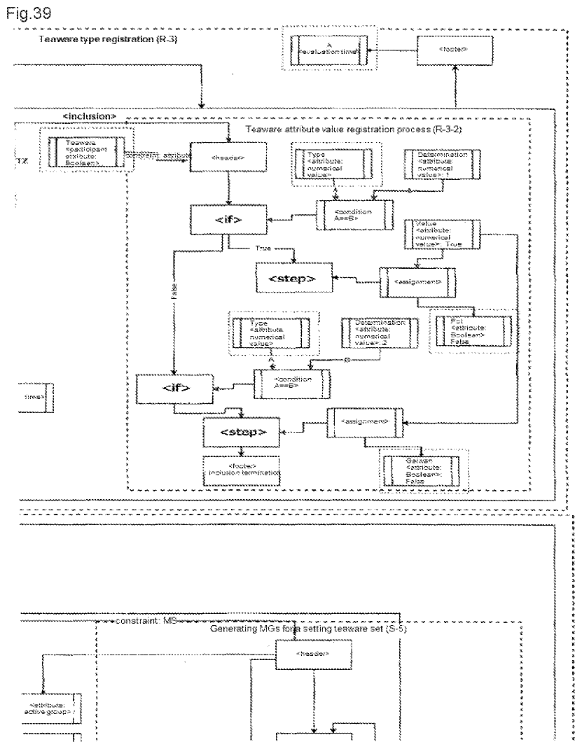

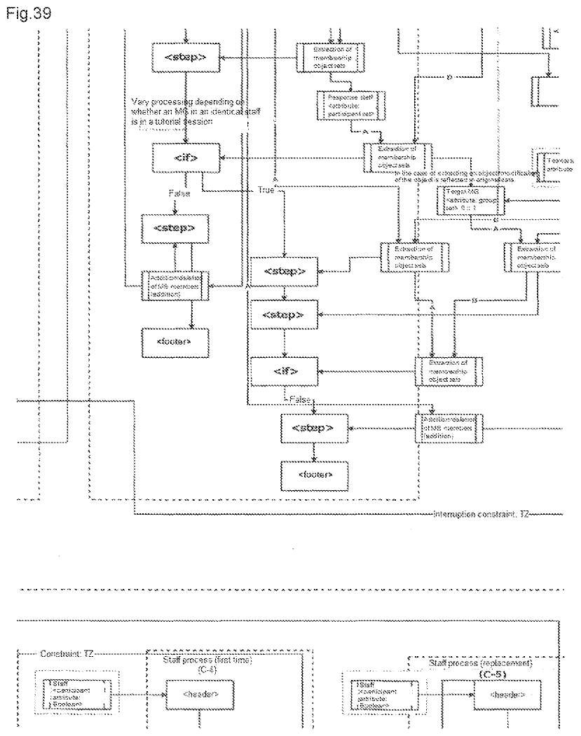

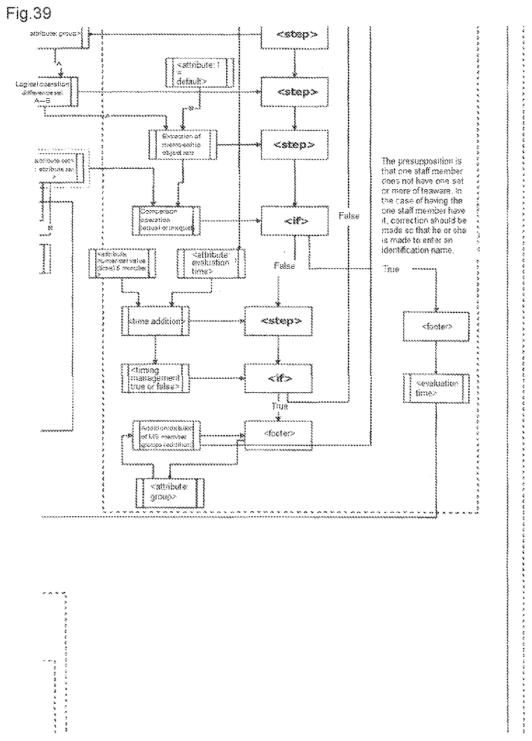

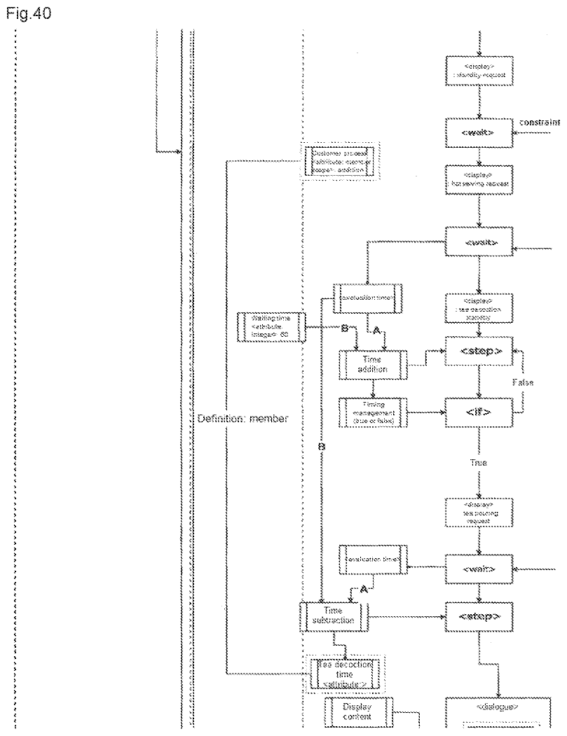

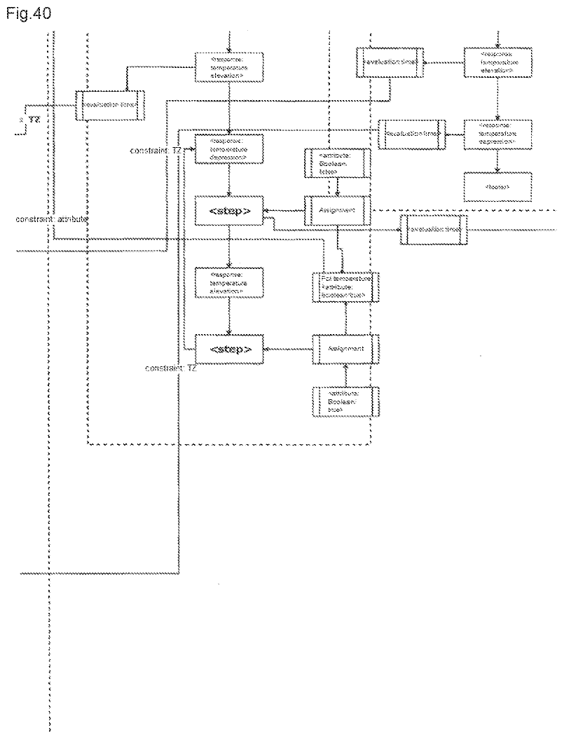

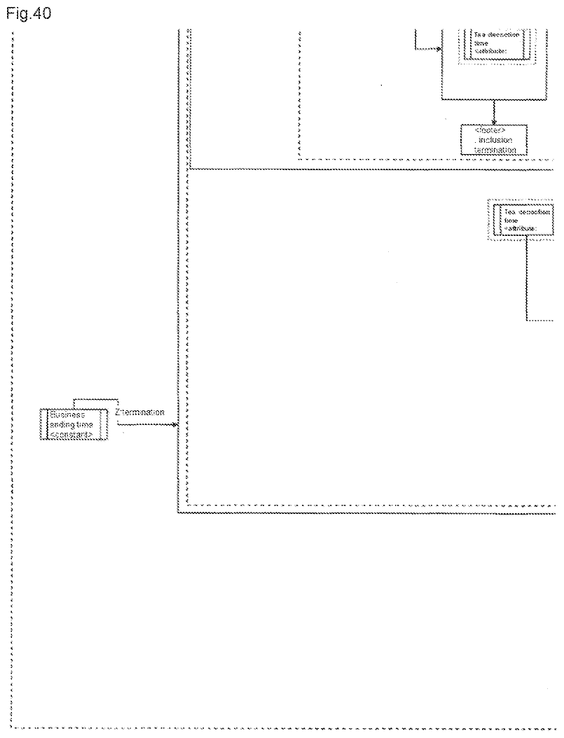

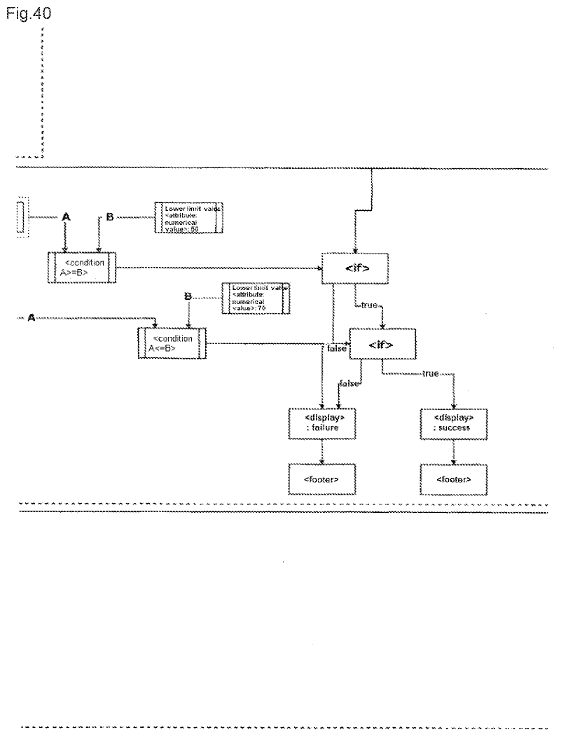

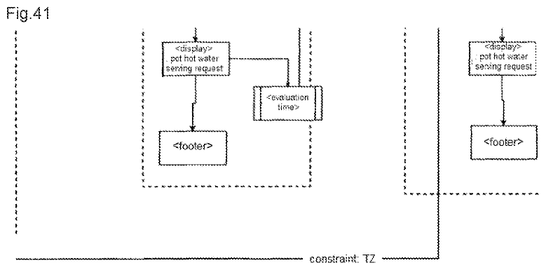

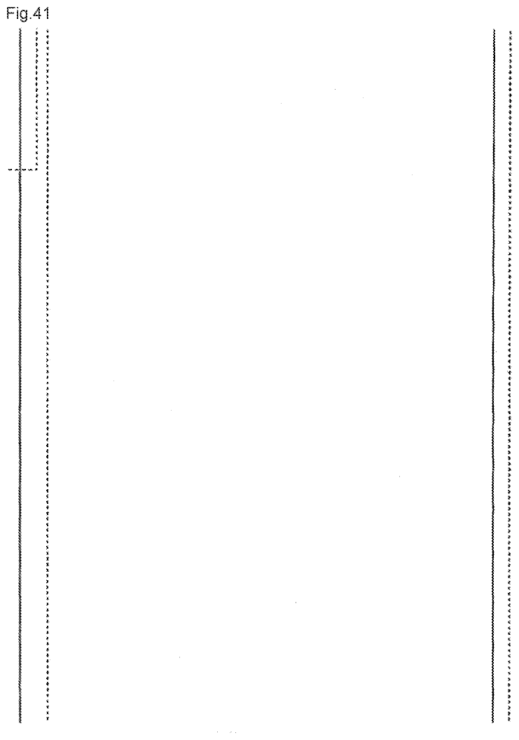

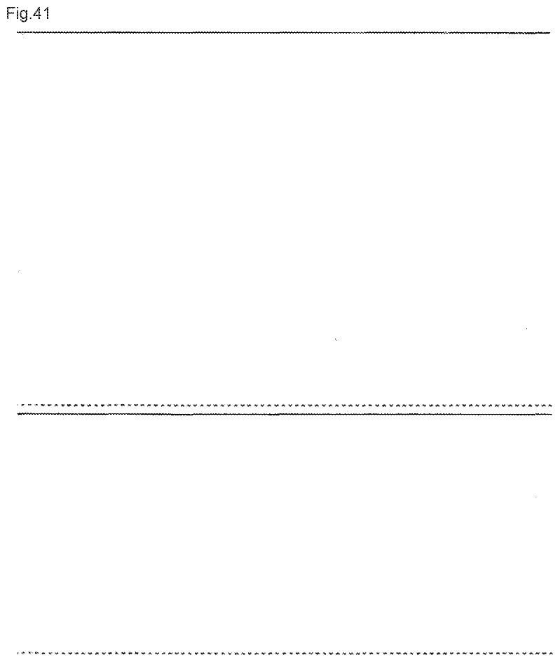

FIG. 37 is a diagram to show dispositional (linkage) relationships between four diagrams from FIG. 38 to FIG. 41. To the right side of FIG. 38, FIG. 41 is linked. To the bottom side of FIG. 38, FIG. 40 is linked. To the bottom side of FIG. 39, FIG. 41 is linked. To the right side of FIG. 40, FIG. 41 is linked.

While four diagrams from FIG. 38 to FIG. 41 being seen as a reference, the embodiment example is described.

C) A tutorial on how to brew Chinese tea (Description on interaction (dialogues/chats) between participants playing different roles)

Embodiment example: To promote sales for process-type consumption goods, and

to distribute a guide for drinking Chinese tea with tea ware equipped with temperature sensing function at a suitable temperature.

Types of participants

A: Guest

B: Staff member

(C: Teaware <Pot, Gaiwan>> When a staff member registers teaware in a registration scene, a dummy participant is generated. A UI block that returns temperature change and a specified temperature is provided.)

1: Teaware consists of a pot*, a gaiwan*, a chahai, a tea bowl.

Those marked with * are equipped with temperature sensing function and have an external module that returns the temperature at a given time to an attribute and generates rapid temperature change (elevation, depression) as a trigger. #Rapid temperature change occurs when hot water is poured into a gaiwan/at the time of pouring hot water thereinto. A pot module does not have a trigger according to temperature change.

2. Process is divided into a reception-confirming scene, a tea-rinsing scene* (not denoted), a first-tea scene* a second-tea scene* (not denoted), a third-tea scene* (not denoted), and an evaluation scene. Scenes marked with * are initiated by the temperature of a gaiwan rising, and are terminated by pouring (temperature depression).

3: For each of the first-tea to third-tea scenes, information is available on suitable temperature zone and suitable tea-decocting time.

>>If a temperature depression response is received from a gaiwan UI block in a period of 60 seconds±10 seconds after a temperature elevation response, normal termination ensues.

4: When a pot is lowered in temperature below a give one, a warning to replace hot water is issued while the process being suspended till the pot arriving at temperature above a given one. >>It occurs if a temperature depression response is received from a pot UI block.

5: A tea scene where temperature deviates extremely from suitable one and a scene where rapid temperature depression has not occurred are seen to be exceptional and are redone. (This sentence is not present in the drawings)

6: In an evaluation scene, a total point is determined by giving 3 points to a scene satisfying conditions of its temperature and decocting time being suitable, and negative one point to a scene failing to do so, and a message of Excellence is distributed to those with 9 points, that of Passed to those with 5 points or more, and a message of Keep your try to those below that.

7: After each of the scenes is terminated, an explanatory article as in the following scene is distributed. That includes moving image part, and if it is not read through until its end, progress is not allowed further, waning is issued and redoing is required.

8: Registration scene >> A staff participant gets into contact with identification data for each device and add a scene previous to being renewed. As for teaware (where an external module that renews library data by acquiring identification information made in a form of URLs is set), a plurality of sets to be used for that day is present.

9: In a reception-confirming scene, one set of the registered teaware is associated with a participant.

A diagram in which the above scenario is configured as a scenario of an event management system. Although this is a model diagram, each of its elements corresponds to the transition instruction relationship between blocks for the case where the blocks are disposed on a GUI editor.

The scenario is numbered in such a manner as (R-1) for each process to transact a BUIB, and explanation shall be made in accordance with the way it is numbered. The whole scenario is constituted by a registration stage made of R-1 to R-3 and the child processes inside the inclusion blocks thereof, a setting stage made of an S process and the inside thereof, and a content stage made of a C process and the inside thereof.

In the registration stage, one is registered as a participant having a teaware attribute on teaware that can be identified at a terminal, by teaware and a staff member.

In the setting stage (a reception-confirming one), a teaware set is constituted by the teaware registered when a customer is registered, and is associated with the customer by a staff member.

In the content stage, a first-tea scene is expressed in a process to transact each of its attributes.

To explain each of the processes

R-1: An attribute set is being made by processing entries for a participant having a staff (participant) attribute as a process of a scenario route (dummy participant), and putting together attributes for each piece of teaware (in order to determine what attribute a piece of teaware which is a setting process has (in order to show a process for each teaware type attribute in a discernible manner in the content stage, although this case is made to be simple by making determination on the basis of an attribute value)).

R-2: Teaware registration. A dialogue to carry out a user check on teaware and register the teaware and to process a (QR/reading) context page for checks, as a staff participant process is called and is made to form loops until each staff member confirms that the registration is terminated. The count of the staff members who made such confirmation is stored in a confirmed sum attribute.

R-2-1: In the case where a user check is carded out on items to be teaware, entries are carried out as the teaware and such group information is stored as a new member group in a user check storage 0. Additional processing is carried out in R-3, and the termination information thereon is returned at A standby time attribute and an inclusion block is closed.

R-3: Attribute registration is carried out for teaware by a member scope in which to put together a group composed of teaware and staff members which have been registered for entry, and when it terminates, it terminates by storing termination time in the A attribute.

R-3-1: It terminates when a staff member enters a teaware type in numerical value on a displayed registration application screen.

R-3-2: It is a teaware process and the attribute value of a gaiwan or a pot is True in accordance with a numerical value entered by the staff member.

R-4: When the times that the staff members terminate registration proceeding go beyond a staff count (the times that they have entered it in total), they proceed to the next stage.

S: A stage at which to carry out customer entry and carry out the setting with teaware in a shop business time (The content process for each customer thereafter is also stored in an inclusion block of a child process. It closes at the business ending time.

S-1: Customer entry processing is carried out and taken in as a member group of a customer process member scope.

S-2: Customers and stuff members carry out user checks, group also a teaware set made by the staff members in such contexts, and open a content page.

S-3: A process for a staff member. A staff member who has returned Entering Response carries out a user check on teaware in order to make a teaware set. When the teaware set is formed, a user check is carried out on customers in S-2.

S-4: Processing on a group of pairs between teaware and a staff member generated by a user check on the teaware, mentioned in S-3. If an existing tea set group (being formed) is present, teaware is added thereto (eliminated if the same kind of teaware is already present) and if not present, it is added to a member scope of a teaware set as a new member group.

S-5: A teaware set group is formed by using a teaware set MS. It is checked on whether the teaware added by loop processing satisfies a configuration for a teaware set and if it satisfies the configuration, the processing terminates.

C: Content stage, a tea-serving process. It manages the serving of first tea in a child process for each attribute. When it is terminated and its inclusion blocks are closed thereby, an evaluation point is calculated for tea decoction.

C-1: Customer process. It serves tea on the basis of the context information according to processes of other participants. Restriction on time is present.

C-2: Pot process. Events are generated by the first temperature elevation and depression, and those thereafter.

C-3: Gaiwan process. Events are generated by temperature elevation and depression.

C-4: First instruction by a staff member to pour hot water.

C-5: Instruction to a pot by a staff member that hot water be replaced when cooled.

<<On the Matter that it is Made Easy to Create an Event by Allowing an Event Creator to Use this Program>>

Since dialogues are fully used, it is made easy for an event creator to carry out creation (In the case where a graphical user interface is used, more understandability is attained).

Since evaluation is made for each evaluation range, what to correct is limited in range and therefore, is easy to make out, even if the evaluation is not good.

Since creation is carried out in accordance with constraints such as those on member scopes, attributes, and time zones, the event creator can carry out the creation without worrying about feasibility.

Since this program works in this way, the event creator can create a feasible event even if he or she is not familiar with computer programming.

<Amendment: Aspects of Interactions and the Parent-Child Relationship Between Member Scopes>

In reference to FIG. 14, the wording of “The member scope can have, instead of a member group, another member scope as a member group. It follows that an MS member of a child MS is a member of a member group.” is present in a describing part ([0049]).

Additionally, in reference to FIG. 15, the wording of “A group context of a higher BUIB is granted to a child BUIB of an inclusion block. In the case where an attribute defined for a higher member scope is used by a child process, an attribute value is referred to in accordance with that group context.” is present in a describing part ([0051]).

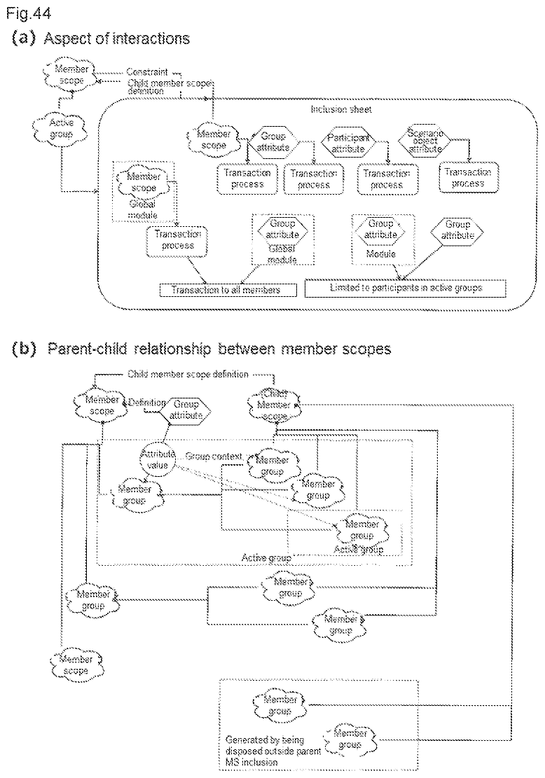

In relation to these matters, amendments and supplements are described in reference to FIG. 44. A member scope (MS) can be defined as a child member scope of another MS. In this case, members of a child MG constitute a subset of members of a group to be defined by a parent.

For definition, whether to be defined for an MS group in the same way as attributes are or to be defined as a subset of an MG group can be chosen (If the subset of an MG is chosen, it follows that an MS instance is generated for each of the MGs).

In the case where nothing is defined, a non-modularly global member scope defined within an inclusive function sheet that has been subjected to MS constraint defines an MG member subset for a constraint MS. A modularly global MS is deemed as an independent MS in the case where it is not defined in terms of relevance.

Within the MS constraint above, attribute constraint is inherited by the inclusion inside.

FIG. 44(a) is a diagram to show the aspect of interaction.

An aspect diagram of interaction: Inside the inclusion constrained by an MS, the processing of participants is limited to an active group. Additionally, there, members for the processing constrained by a child MS and an attribute are limited to targets having membership of an active group. In the case where the MS and the attribute are global modules, the membership is not constrained by inclusion relationship. Which processing is applied to an MS having no statement depends on its properties/implementation.

FIG. 44(b) is a diagram to show the parent-child relationship between member scopes.

A parent-child relationship diagram between member scopes: (A subset) A member group of a child member scope belongs to any of the member groups of a parent MS.

Which member group to belong to is determined on how to behave in an active group. In the case where on an active group (an inclusive function sheet constrained by a parent MS), group operation is carried out (with a child MS disposed thereon), the addition of a group and the increase or decrease of members are carried out by a member of the active group, and the added group belongs to a member group higher than it. In the case where a group operation exceeding the scope of an active group is carried out, it is ignored.

In each of the member groups as well, the MGs of a child MS also inherits this parent-child relationship between member scopes through the behavior of an active group and each of them has a unique parent MG.

Additionally, this parent-child relationship limits also the scope within which group attributes of a parent MG are referred to by group contexts, to the child MGs thereof. In the case where the child MS is disposed outside the constraint process of a parent, groups generated there have no subset relationship.

This system can be applied to an excursion, a group trip, a tour guide planned by a travel agency, a publication commemorating party, a new year's greeting party, a name card exchange party, a birthday party, a meet-up, a quiz competition, a music concert, a live concert, a sport watching, Stamp rally 06, an orienteering competition, a game of communication and competition being carried out by a plurality of participants by using portable terminals, a wedding ceremony, an alumni party, and so on.

### INDUSTRIAL APPLICABILITY

Since the event management system according to the present invention is a system established by connecting a server to terminals, is realized by an OS, application software, a data base, a network system, and so on which are constructed on hardware resources including a CPU, a memory, an auxiliary storage device, a display, an input device, and so on, of a computer, and specifically realizes information processing as event management processing by using the above hardware resources, it falls under a technical idea using natural laws and can be used for event management industry such as traveling.

### EXPLANATION OF SYMBOLS

10 Server
21, 22, 23, 24 Event creator user terminals
31,32,33,34 Participant user terminals
51 API database (API database device)
52 Event database (event database device)
53 User database (user database device)
54 Point database (point database device)
61 API registration processing unit
62 Event creation processing unit
64 Event registration processing unit
65 Communication processing unit
66 Point management unit
67 Event participant participation processing unit
68 Event participant interaction management unit
69 User behavior confirmation unit

1. An event management system comprising:
an API database storing
an event execution management API that executes and manages at least one of scenario execution as a constitutional unit of an event, transmission of messages to and reception thereof from event participant terminals, processing of location information on the event participant terminals, event progress recording, log data collection, and advertisement distribution, and
a resource management API that identifies and manages each physical resource including at least one of a terminal to be operated by the event execution management API, a device, an article of commerce, a building, a place, means of transportation, and means of communication;
an event database that stores an event execution program, and log data generated during such event execution;
an API registration processing unit that receives an API according with a given API definition specification from an API provider terminal and registers it in the API database;
an event creation processing unit that transmits, to an event creator terminal used by an event creator, a given event definition specification and any API selected among APIs stored in the API database and receives, in the event creator terminal, an event execution program created by making an API received in accordance with the event definition specification be a component thereof;
an event registration processing unit that determines whether the created event execution program accords with given criteria for feasibility in the present system and registers, in the event database, an event execution program whose result is affirmative; and
a communication processing unit that transmits information necessary for or related to event execution to and receives it from event participant terminals used by event participants, through a network;
wherein the event execution program
has an object called a member scope which is an array of groups and is a set of participant groups,
an attribute of having an attribute value defined for any one or more of objects constituting the member scope and unique to an object instance,
means of specifying an attribute value by a group context for processing, and
one or more functions to perform a set operation or a relevance extraction operation, and
controls, by limiting participants by the member scope, an interaction between a plurality of the event participants or a plurality of the devices.

2. The event management system according to claim 1, wherein
said means of specifying attribute values includes any one or more of the limitation on participants by a member scope, a current processing group of a member scope, or the limitation on participants by a member scope higher with respect to inclusion relationship.

3. The event management system according to claim 1, wherein
said one or more functions to perform a set operation or a relevance extraction operation include a function that performs a logical operation,
a function that performs relevance extraction between membership objects
a function that performs member scope member group additions and deletions, and a function that performs member scope member additions and deletions.

4. The event management system according to claim 1 which expresses, in a parent-child relationship, a scenario or a time zone by combining a user interface block as a block of said event execution program, a program block, and an evaluation range as a transition dendrogram of the program blocks.

5. The event management system according to claim 1 which expresses, in a parent-child relationship, a scenario or a time zone by a user interface block as a block of said event execution program or an inclusion block including a plurality of program blocks.

6. The event management system according to claim 4, wherein
said user interface block is made of an event creator user interface block and an event participant user interface block, and wherein
said event execution program is run by mutual interrupts of a plurality of event creator user interface blocks.

7. The event management system according to claim 6, wherein
said event execution program has a constraint to act as a block initiation condition, and wherein
said mutual interrupts of a plurality of event creator user interface blocks are integrally managed by the constraint.

8. The event management system according to claim 4, wherein
said event execution program has a constraint to act as a block initiation condition, and wherein
said member scope is integrally managed by the constraint.

9. The event management system according to claim 1, wherein
said event execution program has an interaction connector as a program block to acquire evaluation time information and group information on a transition source and return, if conditions are satisfied when a transition occurs in a transition source group, an evaluation time to a transition destination group,
and manages whole processing and mutual processing by using the interaction connector.

10. The event management system according to claim 1, wherein
said event execution program executes transition timing management by carrying out comparison control between evaluation times, and between addition time operation and current time.

11. The event management system according to claim 4, wherein
said event execution program graphically displays icons including user interface blocks, program blocks, and input/output ports.

12. The event management system according to claim 11, wherein
said event execution program displays, when an event occurs in a related icon among a user interface block, a program block, and input/output ports, a transition arrow leading to the icon and displays, otherwise, only an icon representing a mutual port.

13. The event management system according to claim 5, wherein
a new lower member scope defined in said inclusion block where participants are limited by said member scope is created and managed by a child process where participants are limited by a higher member scope, and wherein
members of a group belonging to the lower member scope constitute a subset of an active group of a higher member scope.

14. The event management system according to claim 1, wherein
said event execution program is made by combining a user interface, a user interface block used for controlling timing and contexts for the user interface, and a program block to define such control in detail, and wherein
said event registration processing unit registers, by executing, for the event execution program, event-driven evaluation processing on the basis of an evaluation range as a transition dendrogram of program blocks surrounded by variable blocks, an event execution program according with said given criteria for feasibility in said event database.

15. An event management system comprising:
an API database storing
an event execution management API that executes and manages at least one of scenario execution as a constitutional unit of an event, transmission of messages to and reception thereof from event participant terminals, processing of location information on the event participant terminals, event progress recording, log data collection, and advertisement distribution, and
a resource management API that identifies and manages each physical resource including at least one of a terminal to be operated by the event execution management API, a device, an article of commerce, a building, a place, means of transportation, and means of communication;
an event database that stores an event execution program, and log data generated during such event execution;
an API registration processing unit that receives an API according with a given API definition specification from an API provider terminal and registers it in the API database;
an event creation processing unit that transmits, to an event creator terminal used by an event creator, a given event definition specification and any API selected among APIs stored in the API database and receives, in the event creator terminal, an event execution program created by making an API received in accordance with the event definition specification be a component thereof;
an event registration processing unit that determines whether the created event execution program accords with given criteria for feasibility in the present system and registers, in the event database, an event execution program whose result is affirmative; and
a communication processing unit that transmits information necessary for or related to event execution to and receives it from event participant terminals used by event participants, through a network;
wherein
the event execution program
limits, by using an object called a member scope which is an array of groups and is a set of participant groups, participants by the member scope, and further
has an interaction connector as a program block to acquire evaluation time information and group information on a transition source and return, if conditions are satisfied when a transition occurs in a transition source group, an evaluation time to a transition destination group, and
manages whole processing and mutual processing by using the interaction connector.

16. An event management system comprising:
an API database storing
an event execution management API that executes and manages at least one of scenario execution as a constitutional unit of an event, transmission of messages to and reception thereof from event participant terminals, processing of location information on the event participant terminals, event progress recording, log data collection, and advertisement distribution, and
a resource management API that identifies and manages each physical resource including at least one of a terminal to be operated by the event execution management API, a device, an article of commerce, a building, a place, means of transportation, and means of communication;
an event database that stores an event execution program, and log data generated during such event execution;
an API registration processing unit that receives an API according with a given API definition specification from an API provider terminal and registers it in the API database;
an event creation processing unit that transmits, to an event creator terminal used by an event creator, a given event definition specification and any API selected among APIs stored in the API database and receives, in the event creator terminal, an event execution program created by making an API received in accordance with the event definition specification be a component thereof;
an event registration processing unit that determines whether the created event execution program accords with given criteria for feasibility in the present system and registers, in the event database, an event execution program whose result is affirmative; and
a communication processing unit that transmits information necessary for or related to event execution to and receives it from event participant terminals used by event participants, through a network;
wherein
the event execution program
controls, by using an object called a member scope which is an array of groups and is a set of participant groups to limit participants by the member scope, an interaction between a plurality of the event participants or a plurality of the devices, and
executes transition timing management by carrying out comparison control between evaluation times, and between addition time operation and current time.

17. An event management system comprising:
an API database storing
an event execution management API that executes and manages at least one of scenario execution as a constitutional unit of an event, transmission of messages to and reception thereof from event participant terminals, processing of location information on the event participant terminals, event progress recording, log data collection, and advertisement distribution, and
a resource management API that identifies and manages each physical resource including at least one of a terminal to be operated by the event execution management API, a device, an article of commerce, a building, a place, means of transportation, and means of communication;
an event database that stores an event execution program, and log data generated during such event execution;
an API registration processing unit that receives an API according with a given API definition specification from an API provider terminal and registers it in the API database;
an event creation processing unit that transmits, to an event creator terminal used by an event creator, a given event definition specification and any API selected among APIs stored in the API database and receives, in the event creator terminal, an event execution program created by making an API received in accordance with the event definition specification be a component thereof;
an event registration processing unit that determines whether the created event execution program accords with given criteria for feasibility in the present system and registers, in the event database, an event execution program whose result is affirmative; and
a communication processing unit that transmits information necessary for or related to event execution to and receives it from event participant terminals used by event participants, through a network;
wherein
the event execution program
controls, by using an object called a member scope which is an array of groups and is a set of participant groups to limit participants by the member scope, an interaction between a plurality of the event participants or a plurality of the devices, and
is made by combining a user interface, a user interface block used for controlling timing and contexts for the user interface, and a program block to define such control in detail, and wherein
the event registration processing unit
registers, by executing, for the event execution program, event-driven evaluation processing on the basis of an evaluation range as a transition dendrogram of program blocks surrounded by variable blocks, an event execution program according with the given criteria for feasibility in the event database.

18. The event management system according to claim 5, wherein
said user interface block is made of an event creator user interface block and an event participant user interface block, and wherein
said event execution program is run by mutual interrupts of a plurality of event creator user interface blocks.
